(19) United States
(12) Patent Application Publication
(10) Pub. No.: US 2002/0087474 A1
(43) Pub. Date: Jul. 4, 2002

(54) Electronic commerce system, electronic commerce method and storage medium

(76) Inventor: Kazumi Suga, Kanagawa (JP)

Correspondence Address: MORGAN & FINNEGAN, L.L.P., 345 PARK AVENUE, NEW YORK, NY, 10154, US

(21) Appl. No.: 09/894,481

(22) Filed: Jun. 27, 2001

(30) Foreign Application Priority Data
Jun. 27, 2000 (JP) 193332/2000

(51) Int. Cl. G06F 17/60

(52) U.S. Cl. 705/50

(57) ABSTRACT

To provide an electronic commerce system having a configuration allowing a general consumer to provide digital contents to be sold to a seller side via a network and thereby solving shortage of the digital contents that will become a problem in the future. For that purpose, in this system, the seller side acquires via a network information on electronic contents that the buyer side wanting to purchase arbitrary electronic contents desires to buy and displays it as a list by using a WWW browser, and in the case where electronic contents desired to sell are among the electronic contents desired to buy listed in the displayed list, the seller side provides the electronic contents to the buyer side via the network.

### BACKGROUND OF THE INVENTION

1. Field of the Invention

The present invention relates to an information processing apparatus, an electronic commerce system and an electronic commerce method that are used, for instance, for an apparatus and a system for conducting sale of goods (electronic commerce) via a network such as the Internet, and a storage medium on which a computer has stored in a readable manner a processing step for implementing those.

2. Related Background Art

Conventionally, there are the following forms, for instance, of commercial transaction between a buyer side (commercial product purchaser side) and a seller side (commercial product seller side).

The seller side either has commercial products to be sold as purchased inventory, or purchases the commercial products as required without having inventory. The buyer side visits a shop of the seller side and purchases desired commercial product.

The buyer side orders by telephone and so on the desired commercial product from the seller side. The seller side delivers the commercial product ordered by the buyer side to its home.

In addition, there are the following forms, for instance, of commercial transaction involving a broker between the buyer side and the seller side.

The seller side determines selling prices of the commercial product and consigns sale thereof to the broker. The broker finds the buyer side and sells the commercial product, and collects a predetermined fee from the seller side.

The seller side determines minimum selling prices of the commercial product and consigns sale thereof to the broker. The broker sells the commercial product to the buyer at a desired price equal to or higher than the minimum selling prices determined by the seller side, and keeps the difference as its profit.

In recent years, however, the electronic commerce (EC) is increasingly thriving in conjunction with consolidation of a communication infrastructure and widespread use of computers.

In the electronic commerce system, computers (hereafter, also referred to as “terminal units”) of the buyer side and the seller side are connected to a network such as the Internet, and mutual communication is performed via the network between the buyer side and the seller side so as to sell and buy various kinds of commercial products.

In addition, in the electronic commerce system, there is also a service conducted, wherein information on the commercial products to be sold is published by the seller side on a WWW (World Wide Web) server managed and operated by the seller side and the buyer side accesses the seller-side WWW server to purchase desired commercial product.

The commercial products in this case include the following.

(1) So-called articles such as day-to-day goods and automobiles.

(2) Digital contents such as an image source, an audio (music) source, static images and game software.

In the electronic commerce between the seller side and the buyer side when the buyer side purchases the commercial products (articles) of the (1), a user on the buyer side first activates a WWW (World Wide Web) browser (Internet contents acquiring and browsing software) on his or her own terminal unit connected to the seller side via the Internet and thereby acquires and displays on the screen an HTML (Hypertext Markup Language) file including commercial product information and so on from the WWW server managed and operated by the seller side so as to browse the commercial products sold on the seller side on the displays screen.

It is equivalent of the buyer side reaching a home page provided by the seller side by performing net surfing (wandering about on various home pages on the Internet) with the WWW browser and viewing the home page.

Next, the user on the buyer side selects a desired commercial product on the home page on the seller side, and then sends as a purchase request to the WWW server on the seller side his or her own authentication information entered on the entry form on the home page together with the commercial product information by the WWW browser again.

And the seller side receives the purchase request from the buyer side, and authenticates the user on the buyer side, and then sends the commercial product requested from the buyer side and also collects the price of the commercial product. A method of collecting the price at this time includes credit card settlement and so on.

On the other hand, as for the electronic commerce between the seller side and the buyer side in the case where the buyer side purchases a commercial product of the (2) (digital contents), a method of distributing the digital contents by the Internet is adopted.

To be more specific, there are a download method and a streaming method as distribution methods of the digital contents such as an image source and an audio (music) source (hereafter, also referred to as “image data” and “audio data”) via the Internet (Internet distribution method).

The download method is a method wherein the buyer side downloads the desired digital contents such as image data and audio data from the WWW server on the seller side to its own terminal unit so as to store the digital contents on a record medium or reproduce them by reproduction-specific software.

The streaming method is a method wherein the buyer side receives and simultaneously reproduces by its own terminal unit the digital contents sent by the WWW server on the seller side. This method has an advantage that waiting time as required for download by the download method is not necessary.

Of the above-mentioned download and streaming methods, while the download method is more often used in the electronic commerce, it is expected that the streaming method will be increasingly popular in the future.

For instance, in the case of the electronic commerce of the digital contents by the download method, the user on the buyer side first activates the WWW browser on his or her own terminal unit connected to the seller side via the Internet and thereby acquires and displays on the screen an HTML file including the digital contents information and so on from the WWW server managed and operated by the seller side so as to browse the digital contents sold on the seller side on the displays screen.

At this time, the user on the buyer side is registered as a member by disclosing in advance by the WWW browser his or her personal information and credit card information to the seller side at a digital contents distribution service site operated by the seller so as to acquire a user ID and a password from the seller side.

Next, the user on the buyer side selects desired digital contents on the home page on the seller side, and then operates a download button. A user authentication screen is displayed on the terminal unit on the buyer side by this operation.

The user on the buyer side inputs the user ID and password acquired from the seller side in advance on the authentication screen.

And the seller side performs user authentication by the user ID and password inputted by the buyer side, and then permits the download by the user.

Thus, the buyer side starts downloading the digital contents desired by the user.

Thereafter, the seller side performs settlement based on the credit card information registered in advance by the user on the buyer side.

In addition, in the above-mentioned electronic commerce, there are cases where a form involving a broker between the buyer side and the seller side is adopted. Hereafter, such electronic commerce is also referred to as “electronic commercial product sale brokerage transaction.”

In this electronic commercial product sale brokerage transaction, for instance, the broker side publishes the commercial product information on its home page and so on with selling prices determined by the seller side. The buyer side browses it and contacts the broker side by telephone and so on. The buyer side and the broker side actually negotiate the sale of the commercial product desired by the buyer side. The broker side collects a brokerage fee from and the seller side after conclusion of the sale.

However, there have been the following problems in the above-mentioned conventional electronic commerce of the digital contents.

While the electronic commerce of the digital contents seems to increasingly expand in the future, it is consequently expected that shortage of the digital contents to be sold will become a serious problem.

In addition, while for instance, some professional artists are providing the digital contents created on their own to the seller side that is a party to an agreement (in this case, only solicited contents information is electronified), it is only the limited number of people called the professional artists that can provide the digital contents to the seller side, and so there arises a problem, as expected, of the shortage of the digital contents to be sold as the electronic commerce expands.

On the other hand, as to the form wherein the broker is involved between the buyer side and the seller side in the electronic commerce (electronic commercial product sale brokerage transaction), it is far from having become electronified and convenient since only the information on the commercial product to be sold is published on the home page and so on and actual dealings in this case are negotiated by the broker side and the buyer side by telephone as in old days.

Accordingly, in the conventional electronic commerce, there has been neither a form wherein the digital contents (electronic contents) are provided by the general user (general consumer) to the seller side nor a form wherein negotiation between the broker side and the buyer side in an electronic commercial product sale brokerage transaction is electronified.

For this reason, neither the problem of the shortage of the digital contents to be sold could be solved nor efficient electronic commerce could be implemented.

### SUMMARY OF THE INVENTION

Thus, the present invention was implemented in order to eliminate the drawbacks, and its object is to provide an information processing apparatus, an electronic commerce system and an electronic commerce method having a configuration allowing a general consumer to provide digital contents to be sold to a seller side via a network and thereby solving shortage of the digital contents that will become a problem in the future, and a storage medium on which a computer has stored in a readable manner a processing step for implementing those.

Another object of the present invention is to provide an information processing apparatus, an electronic commerce system and an electronic commerce method having a configuration wherein commercial product sale consignment from the seller side to a broker side and commercial product sale from the broker side to a buyer side are entirely electronified except physical distribution, a commercial product check and part of price settlement, and brokerage fees are clearly published on the network, whereby soundness of commercial product trade is improved, and [wait-to-sell] (finding a seller side of a commercial product that a buyer side desires to purchase) and [wait-to-buy] (finding a buyer side of a commercial product that a seller side desires to sell) are allowed, sale is possible regardless of the type of commercial products, a flow of commercial product sale can be accelerated, and commercial product sale can be promptly and securely implemented, and a storage medium on which a computer has stored in a readable manner a processing step for implementing those.

Under these objects, the information processing apparatus of the present invention is one of the seller side capable of sale transaction of electronic contents via a network, characterized by having acquiring means for acquiring via the network information on the electronic contents desired to purchase by the buyer side desirous of purchasing arbitrary electronic contents, and a first providing means for providing to the buyer side via the network the electronic contents desired to sell corresponding to the information acquired by the acquiring means.

In addition, the information processing apparatus of the present invention is one of the buyer side capable of a sale transaction of the electronic contents via a network, characterized by having a first providing means for providing via the network information on the electronic contents desired to buy to an arbitrary user on the network, and a first acquiring means for acquiring the electronic contents desired to sell provided according to the information provided by the first providing means from the arbitrary user via the network.

Moreover, the information processing apparatus of the present invention is one capable of a sale transaction of commercial products via a network, characterized by having acquiring means for acquiring via the network at least either sale information that is information on a commercial product desired by the seller to sell or purchase information that is information on a commercial product desired to purchase by the buyer, and responding means for responding via the network with purchase or sale to the sale information or the purchase information acquired by the acquiring means.

Furthermore, the electronic commerce system of the present invention is one for conducting an electronic contents sale transaction between the seller side and the buyer side via a network, characterized by including a terminal unit on the seller side capable of activating information acquiring and browsing software, a terminal unit on the buyer side, a server unit managed and operated by the buyer side for managing at least either the information on the electronic contents desired to purchase by the buyer side or personal information on the seller side, sending and receiving data files according to a request by the information acquiring and browsing software on the seller side, and having a data storage area opened to the buyer side for receiving the electronic contents sent from the seller side, a terminal unit on a financial institution side for performing a transfer transaction to the seller side according to a request from the buyer side, and a communication network for connecting in a manner capable of communication the terminal unit on the seller side, the terminal unit on the buyer side, the server unit and the terminal unit on the financial institution side.

In addition, the electronic commerce system of the present invention is one for conducting a sale transaction of arbitrary commercial products between the seller side and the buyer side via a network, characterized by including a terminal unit on the seller side capable of activating information acquiring and browsing software, a terminal unit on the buyer side capable of activating information acquiring and browsing software, a terminal unit on the commercial product sale broker side, a server unit managed and operated by the broker side, a terminal unit on a distributor side for at least conducting either distribution of the commercial product or receipt of a price of the commercial product according to a request by the broker, and a communication network for connecting in a manner capable of communication at least one of the terminal unit on the seller side, the terminal unit on the buyer side, the terminal unit on the broker side, the server unit and the terminal unit on the distributor side.

Moreover, the electronic commerce system of the present invention is one for conducting a sale transaction of arbitrary commercial products between the seller side and the buyer side via a network, characterized by including a terminal unit on the seller side capable of activating information acquiring and browsing software, a terminal unit on the buyer side capable of activating information acquiring and browsing software, a terminal unit on the commercial product sale broker side, a server unit managed and operated by the broker side, and a communication network for connecting in a manner capable of communication at least one of the terminal unit on the seller side, the terminal unit on the buyer side, the terminal unit on the broker side and the server unit.

Furthermore, the electronic commerce method of the present invention is one for conducting an electronic contents sale transaction between the seller side and the buyer side via a network, characterized by including: a step that the seller side uses the information acquiring and browsing software to access the server unit managed and operated by the buyer side and perform membership registration; a step that the seller side acquires from the server unit on the buyer side a data file including information on the electronic contents desired to purchase by the buyer side and displaying the data file by using the information acquiring and browsing software, a step that the seller side acquires the software required for this trade from the server unit on the buyer side; a step that the seller side evaluates the electronic contents to be provided to the buyer side by using the contents evaluation software included in the software required for this trade; a step that the seller side sends to the buyer side at least one of a contents number for identifying the electronic contents to be provided to the buyer side, member authentication information on the membership registration, and the evaluation results; a step that the buyer side sends to the seller side at least one of an evaluated price, a reception number, key information used for encryption and electronic contents destination information for the subject electronic contents indicated by the contents number based on the evaluation results; a step that the seller side sends the subject electronic contents encrypted by using the encryption key to the buyer side when convinced of the evaluated price; and a step that the buyer side checks the subject electronic contents sent from the seller side and requests the financial institution to transfer the amount of the evaluated price to the seller side for payment via the network.

In addition, the electronic commerce method of the present invention is one for conducting an electronic contents sale transaction between the seller side and the buyer side via a network, characterized by including: a step that the seller side uses the information acquiring and browsing software to access the server unit managed and operated by the buyer side and perform membership registration; a step that the seller side acquires from the server unit on the buyer side a data file including information on the electronic contents desired to purchase by the buyer side and displaying the data file by using the information acquiring and browsing software; a step that the seller side acquires the software required for this trade from the server unit on the buyer side; a step that the seller side uses contents conversion software included in the software required for this trade to degrade the electronic contents to be provided to the buyer side and sends the degraded electronic contents as the electronic contents for evaluation to the buyer side; a step that the server unit on the buyer side sends to the seller side the reception number for the electronic contents sent from the seller side; a step that the buyer side evaluates the electronic contents for evaluation sent from the seller side; a step that the buyer side sends the evaluation results together with the reception number to the seller side; a step that the seller side encrypts and sends the subject electronic contents indicated by the reception number to the buyer side when convinced of the evaluation results; and a step that the buyer side checks the subject electronic contents sent from the seller side and requests the financial institution to transfer the amount of the evaluated price to the seller side for payment via the network.

### BRIEF DESCRIPTION OF THE DRAWINGS

FIG. 1 is a block diagram showing a configuration of an electronic commerce system to which the present invention is applied in a first embodiment;

FIG. 2 is a block diagram showing a configuration of a terminal unit used by a seller side, a buyer side and so on of the electronic commerce system;

FIG. 3 is a flowchart for explaining operation of the electronic commerce system;

FIG. 4 is a diagram for explaining an example of a screen for membership registration in the electronic commerce system;

FIG. 5 is a diagram for explaining an example of a screen for completion of membership registration;

FIG. 6 is a diagram for explaining an example of a screen of a commercial product (contents) sale information list in the electronic commerce system;

FIG. 7 is a diagram for explaining an example of a screen for downloading software for evaluating the contents in the electronic commerce system;

FIG. 8 is a diagram for explaining an example of a screen of the contents evaluation results;

FIG. 9 is a diagram for explaining an example of a screen of notifying the contents evaluation results;

FIG. 10 is a diagram for explaining the contents evaluation process;

FIG. 11 is a diagram for explaining an encryption process in the electronic commerce system;

FIG. 12 is a diagram for explaining a process of decrypting results of the encryption process;

FIG. 13 is a flowchart for explaining operation of the electronic commerce system in a second embodiment;

FIG. 14 is a diagram for explaining an example of a screen of the contents evaluation results in the second embodiment;

FIG. 15 is a flowchart for explaining operation of the electronic commerce system in a third embodiment;

FIG. 16 is a block diagram showing a configuration of an electronic commerce system to which the present invention is applied in a fourth embodiment;

FIG. 17 is a flowchart for explaining operation of the electronic commerce system;

FIG. 18 is a diagram for explaining an example of a screen of a commercial product sale information list in the electronic commerce system;

FIG. 19 is a diagram for explaining an example of a screen for determining a scheduled distribution date of a commercial product in the electronic commerce system;

FIG. 20 is a diagram for explaining another example of the screen for determining the scheduled distribution date of the commercial product;

FIG. 21 is a flowchart for explaining operation of the electronic commerce system in a fifth embodiment;

FIG. 22 is a diagram for explaining an example of a screen of the commercial product sale information list in the fifth embodiment;

FIG. 23 is a block diagram showing a configuration of an electronic commerce system to which the present invention is applied in a sixth embodiment; and

FIG. 24 is a flowchart for explaining operation of the electronic commerce system.

### DESCRIPTION OF THE PREFERRED EMBODIMENTS

Embodiments of the present invention will be described below by using the drawings.

<Main points of first to third embodiments>

First, the main points of the first to third embodiments will be described.

In the first embodiment, the following are entirely electronified in order to render commercial product (contents) trade more efficient.

(a) Membership registration

(b) Soliciting contents

(c) Contents evaluation

(d) Notifying evaluation results

(e) Sending contents

(f) Price payment

The most characteristic configuration of the first embodiment is in the (1) to (9) below.

(1) The buyer side presents a guide for a purchase price to the seller side. It makes commercial product trade between the buyer side and the seller side efficient.

(2) The buyer side limits the contents desired to purchase (hereafter, referred to as “solicited contents”). Thus, the buyer side can acquire the desired contents.

(3) The buyer side has the seller side automatically evaluate its contents. It can save unnecessary work on the buyer side.

(4) The seller side evaluates its contents on its own. It can prevent the contents from being unduly given over to the buyer side.

(5) The evaluation results of contents on the seller side are encrypted and outputted. Thus, the seller-side can prevent the evaluation results from being unduly changed.

(6) If the seller side is not satisfied with the evaluation results of the contents, it can reject sale of the contents.

(7) The seller side encrypts and sends the contents to the buyer side. Thus, no one except the authentic buyer side having the right to receive the contents can decrypt the encrypted contents to acquire the original contents.

(8) The contents are sent from the seller side to the buyer side via a network. It reduces processing time and saves unnecessary work.

(9) The buyer side checks the contents and then pays the price. It allows the buyer side to conduct secure payment.

In the second embodiment, while only (c) contents evaluation of the processes shown in the (a) to (f) in the first embodiment is performed by subjective evaluation on the buyer side, at this time the seller side degrades the contents to arbitrary software and provides them to the buyer side.

The most characteristic configuration of the second embodiment is in the following (10) and (11) in addition to the (1), (2) and (6) to (9) in the first embodiment.

(10) The seller side sends the degraded contents as contents for evaluation to the buyer side. It can prevent the contents from being unduly given over to the buyer side.

(11) The buyer side performs evaluation of the contents from the seller side personally and by subjective evaluation. It allows more advanced evaluation of the contents.

In the third embodiment, in the case where contents evaluation by contents evaluation software is impossible, the contents evaluation is performed personally and by subjective evaluation again as in the second embodiment.

The most characteristic configuration of the third embodiment is in the following (12) in addition to the (1), (2) and (6) to (9) in the first embodiment and (10) and (11) in the second embodiment.

(12) Contents evaluation is personally performed again only to the contents of which contents evaluation could not be automated. It makes contents evaluation more efficient.

### First Embodiment

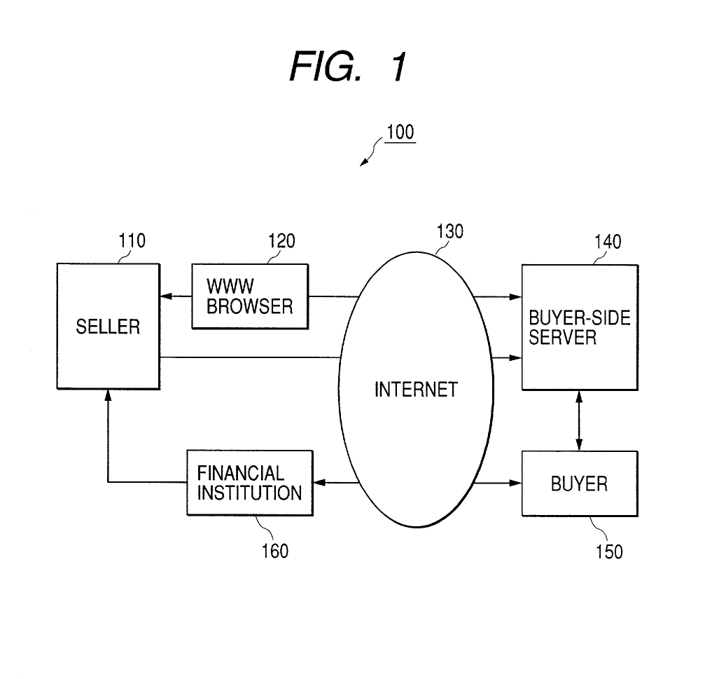

The present invention is applied, for instance, to an electronic commerce system 100 as shown in FIG. 1. (Configuration of the electronic commerce system 100)

As shown in the FIG. 1, the electronic commerce system 100 has a configuration wherein a seller-side terminal unit 110 (hereafter, merely referred to as “seller side 110”), a WWW browser 120 operated and managed from the seller side 110, a buyer-side terminal unit 150 (hereafter, merely referred to as “buyer side 150”), a buyer-side server 140 operated and managed from the buyer side 150, and a terminal unit on a financial institution side 160 (hereafter, merely referred to as “financial institution side 160”) are mutually connected in a manner capable of communication via a network 130 such as the Internet (the Internet in this case).

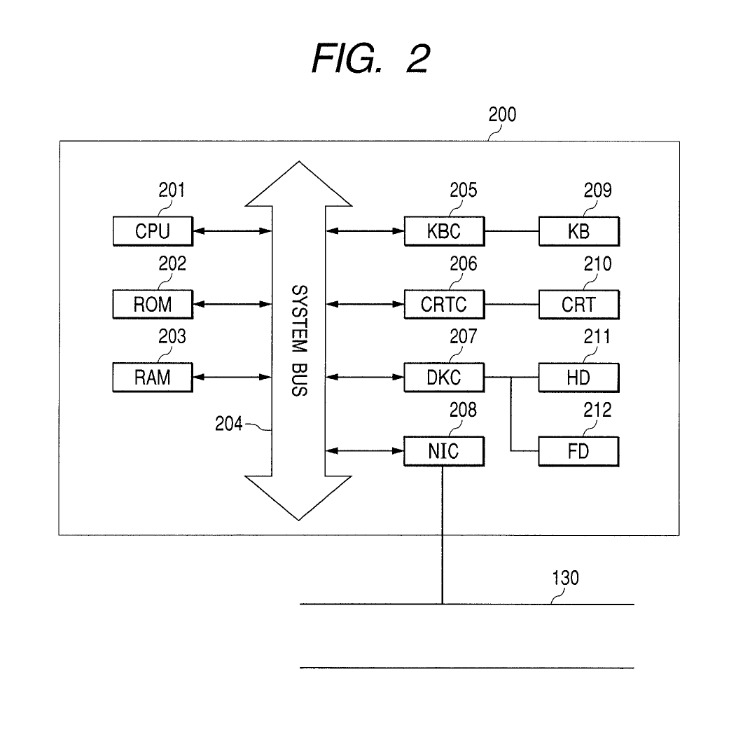

The seller side 110, the buyer side 150, the buyer-side server 140, and financial institution side 160 have functions of a computer 200 of a configuration shown in FIG. 2 for instance respectively, and operation of the electronic commerce system 100 in this embodiment is performed by a CPU 201 in the computer 200.

To be more specific, as shown in the FIG. 2, the computer 200 has a configuration wherein the CPU 201, a ROM 202, a RAM 203, a keyboard controller (KBC) 205 of a keyboard (KB) 209, a CRT controller (CRTC) 206 of a CRT display (CRT) 210 as a display division, a disk controller (DKC) 207 of a hard disk (HD) 211 and a floppy disk (FD) 212, and a network interface card (NIC) 208 are mutually connected in a manner capable of communication via a system bus 204.

And the system bus 204 is connected to the Internet 130 shown in the FIG. 1.

The CPU 201 runs the software stored in the ROM 202 or the HD 211, or the software supplied by the FD 212 so as to place the components connected to the system bus 204 under its overall control.

To be more specific, the CPU 201 exerts control to implement operation of the electronic commerce system 100 in this embodiment by reading from the ROM 202, the HD 211 or the FD 212 and running a processing program according to a processing sequence in this embodiment mentioned later.

The RAM 203 functions as a main memory or a work area of the CPU 201.

The KBC 205 controls input of designations from the KB 209, an unillustrated pointing device and so on.

The CRTC 206 controls display of the CRT 210.

The DKC 207 controls access to the HD 211 and the FD 212 for storing a boot program, various applications, an editing file, a user file, a network management program, and the processing program and so on.

The NIC 208 bi-directionally exchanges various data via the Internet 130.

Moreover, while the FIG. 1 shows a configuration wherein one each of the seller side 110, the buyer side 150 and the financial institution side 160 are connected onto the Internet 130 for convenience of description, it is not limited to this number of connections.

The seller side 110 is on the side of selling digital contents, and includes the terminal unit having functions of the computer 200 shown in the FIG. 2 and activates the WWW browser 120 software thereon to sell the digital contents by communication with the buyer side 150 on the Internet 130.

The buyer side 150 is on the side of purchasing the digital contents sold on the seller side 110, provides sale information of the digital contents to the seller side 110 via the buyer-side server 140, and purchases (acquires) the digital contents from the seller side 110 and then requests the financial institution side 160 to pay the price.

The WWW browser 120 includes client software for running on the terminal unit of the seller side 110, displays in a suitable format the data file in an HTML format and so on, for instance, on the screen thereof, and sends and receives the data file to and from the buyer-side server 140.

In addition, the WWW browser 120 is an optimized browser having a GUI (Graphic User Interface). It allows a user on the buyer side 150, for instance, to utilize electronic commerce services even in the case he or she does not know detailed workings of the electronic commerce services or the buyer-side server 140.

As for the WWW browser 120, Netscape Navigator (trademark) of Netscape Communications Corp., Internet Explorer (trademark) of Microsoft Corp. and so on are applicable.

The buyer-side server 140 has the functions of an HTTP (Hyper Text Transfer Protocol) server and an FTP (File Transfer Protocol) server.

In addition, the buyer-side server 140 includes a server program, and activates the server program to perform services according to a request from the WWW browser 120 and notify results thereof and also return the data file (a file in an HTML format and so on) according to the request.

Furthermore, the buyer-side server 140 has a data storage area opened to the seller side 110, and for instance, receives the digital contents FTP-transmitted from the seller side 110 and stores them in the data storage area.

Moreover, the buyer-side server 140 updates data such as the digital contents sale information and makes a request for a transfer to the financial institution side 160.

The financial institution side 160 includes a financial institution in alliance with the buyer side 150, and transfers the price to the seller side 110 according to the request from the buyer-side server 140.

The Internet 130 is a type of a communication network, and uses a network protocol such as a TCP/IP protocol for instance.

The network protocol in this case provides a standard processing sequence for the terminal units to mutually communicate, and indicates how to format the data in the case of sending and receiving it via the Internet 130, and so on. It allows seamless communication even if the terminal unit of the other party is a different model.

Moreover, HTTP, FTP and SMTP and so on can be named as the standard network protocols. As for the HTTP, it is described in detail in a commercial product of T. Bemers Lee, R. Fieldig and H. Frystyk “Hypertext Transfer Protocol/HTTP/1.0: Sep. 4, 1995” and so on. In addition, the FTP is described in detail in the commercial product of J. B. Postel and J. K. Reynolds “File Transfer Protocol (FTP): RFC959, Information Sciences Institute, USC, Oct., 1985” and so on. Also, the SMTP is described in detail in the commercial product of J. B. Postel “Simple Mail Transfer Protocol: RFC821, Information Science Institute, USC, Aug., 1982” and so on.

(Operation of the electronic commerce system 100)

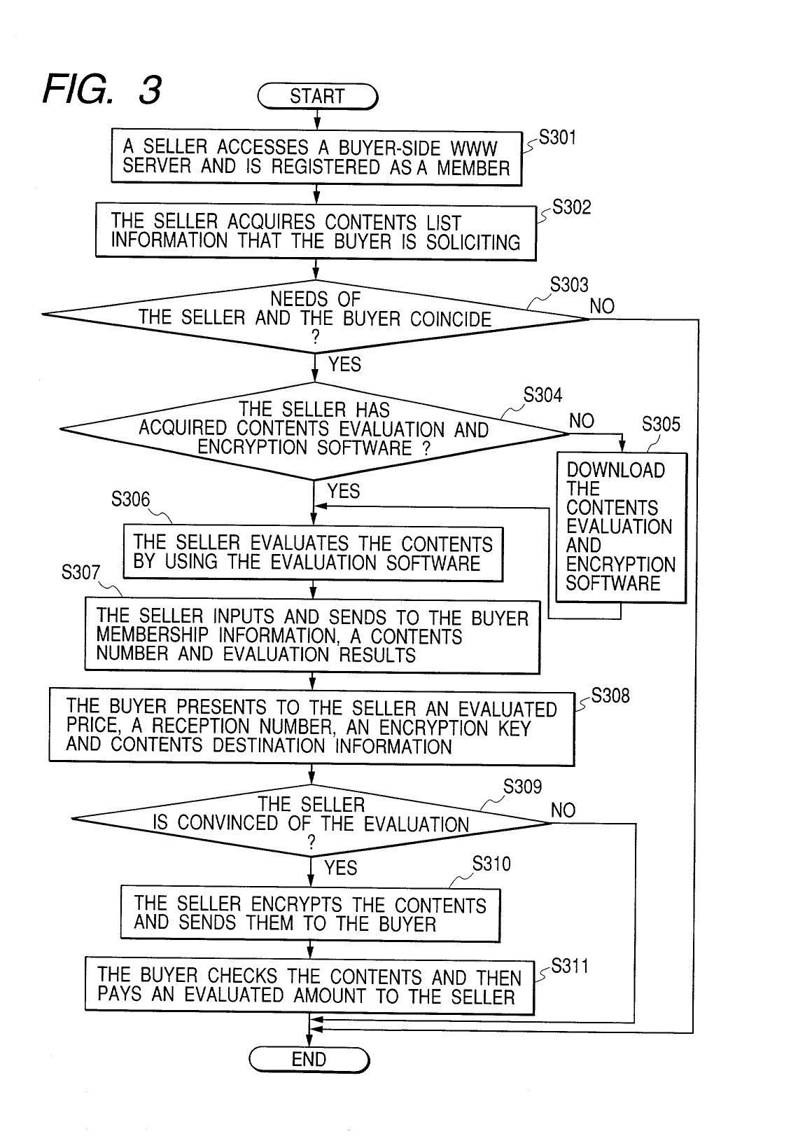

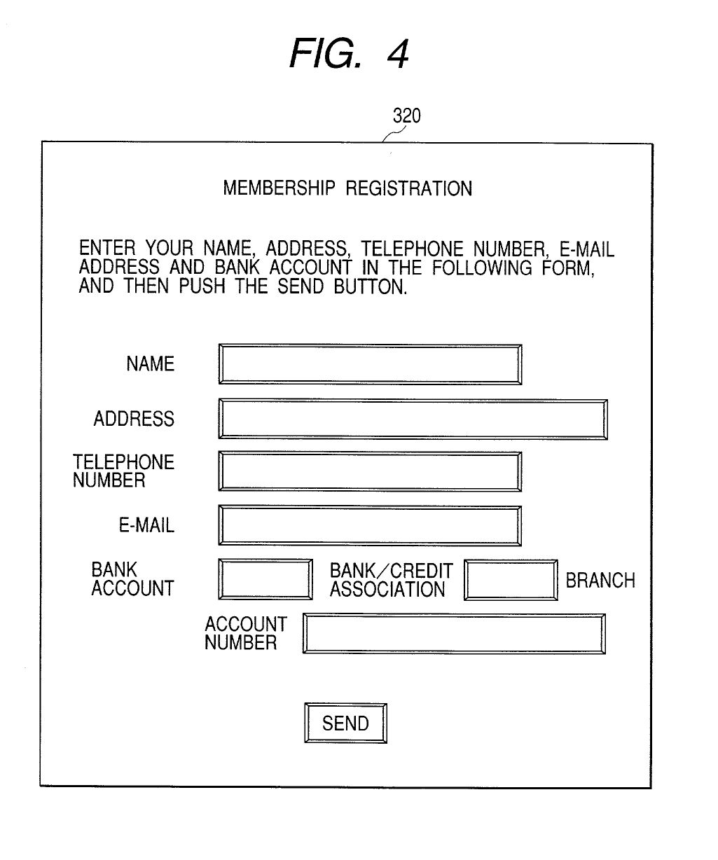

FIG. 3 shows operation of the electronic commerce system 100, and FIG. 4 to FIG. 12 show examples of the screen in the operation and a concept of encryption.

Moreover, in the following description, a “page” indicates a display screen on the terminal unit of the seller side 110 on which the data files in the HTML format and so on acquired by an operator of the seller side 110 from the buyer-side server 140 by using the WWW browser 120 are screen-displayed.

Step S301: (see FIG. 3)

The user of the seller side 110 operates on the terminal unit display screen with the WWW browser 120 running on the terminal unit (including a TV set and a terminal unit of an electronic organizer and so on) on his or her side connected to the Internet 130 and accesses the page of the buyer side 150 specified by a predetermined URL (an address on the Internet 130) so as to be registered as a member.

Moreover, the member registration process in this case will be mentioned later.

Step S302:

The user of the seller side 110 acquires the contents list information currently solicited by the buyer side 150 by accessing the page of the buyer side 150.

FIG. 6 shows an example of the screen 340 according to the contents list information currently solicited. This screen 340 shows a maximum and minimum prices for buying the contents. It allows the user of the seller side 110 to easily recognize the guide for sale of the contents and save the work of fruitless correspondence.

Step S303:

The user of the seller side 110 determines, by seeing the screen 340 of the FIG. 6, whether or not he or she has the contents requested by the buyer side 150 and whether or not a convincing price (a purchase price) is presented as to the contents (whether or not the needs of the buyer side 150 coincide).

As a result of this determination, in the case where the needs of the buyer side 150 do not coincide, the user of the seller side 110 terminates this process.

Step S304:

As a result of the determination of the step S303, in the case where the needs of the buyer side 150 coincide, the user of the seller side 110 requests the buyer side 150 to sell the contents by pushing a “Want to sell” button provided to applicable contents information, and so on in FIG. 6.

And the user of the seller side 110 determines whether or not the contents evaluation software for evaluating his or her own contents to be sold and contents encryption software mentioned later have already been acquired.

As a result of this determination, only in the case where they have not been acquired, the user proceeds to the step S306 via the next step S305. In the case where they have been acquired, the user proceeds to the step S306 as-is.

Step S305:

As a result of the determination of the step S304, in the case where the contents evaluation software and contents encryption software have not been acquired, that is, for instance, in the case where the user of the seller side 110 has not acquired the software since he or she uses the system 100 for the first time or for a similar reason, the user on the seller side 110 downloads the software from the buyer-side server 140 to his or her own terminal unit.

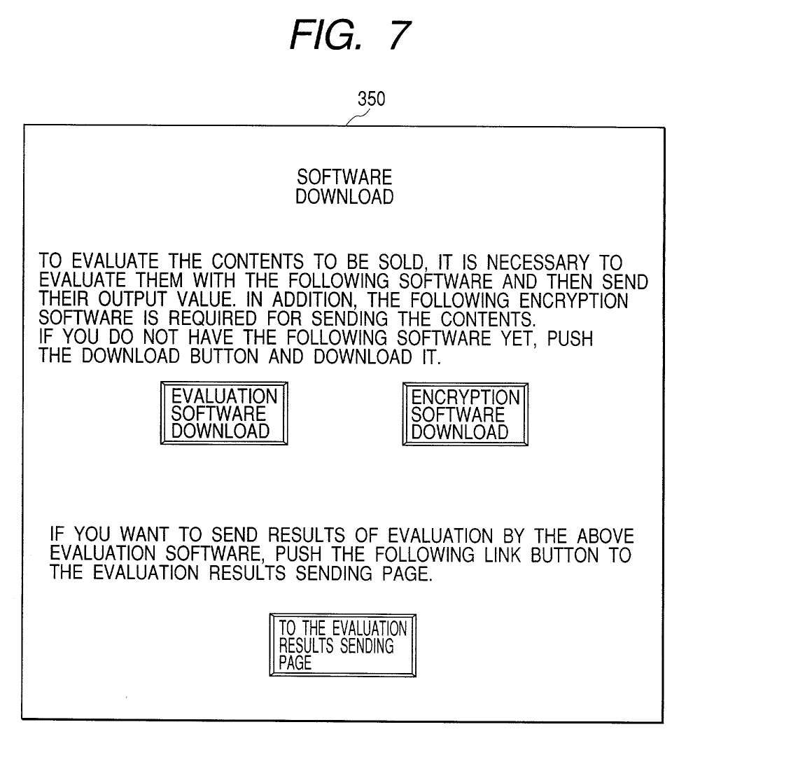

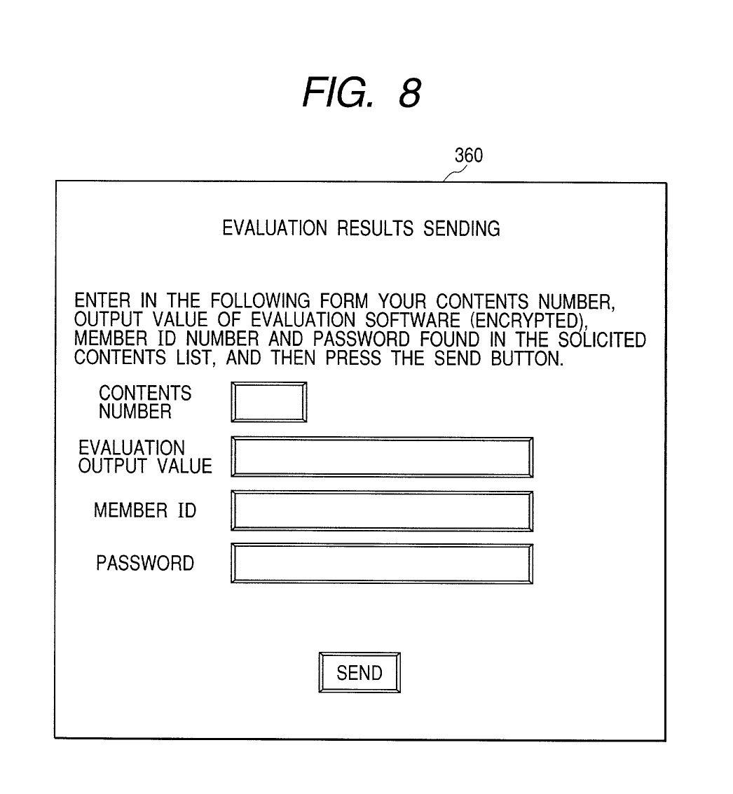

To be more specific, for instance, if the seller side 110 accesses the buyer-side server 140, a screen (download page) 350 as shown in FIG. 7 is displayed on the terminal unit of the seller side 110. The user of the seller side 110 downloads the contents evaluation software and the contents encryption software not yet acquired to his or her own terminal unit by operation on the screen 350.

Moreover, while the contents evaluation process by running the contents evaluation software will be mentioned later, the evaluation results of the subject contents by the process are outputted as encrypted symbols (numbers, alphabet, arithmetic symbols and so on) so as not to be unduly manipulated by the seller side 110. As for the encryption scheme in this case, various encryption schemes are applicable, such as RSA (public key encryption) and DES (Data Encryption Standard), so that it may be any encryption scheme as far as rules of the encryption thereof are not known to the seller side 110.

In addition, a reason for leaving the contents evaluation process to the seller side 110 is to prevent the contents owned by the seller side 110 from being unduly given over to the buyer side 150.

Moreover, it is also possible to have the contents evaluation process performed by a JAVA applet for instance, rather than by software (application). The JAVA applet is a JAVA intermediate language file in a format executable on the page, a programming language not dependent on a platform developed by Sun Microsystems, USA. In this case, it is not required to force the seller side 110 to download and store the contents evaluation software. This is effective in the case where there is not enough storage capacity on the terminal unit of the seller side 110 or in the case where the user of the seller side 110 is not accustomed to operation of the terminal unit, and so on.

Step S306:

The user of the seller side 110 activates the contents evaluation software on his or her own terminal unit to evaluate his or her own contents to sell.

Step S307:

The user of the seller side 110 pushes a “To the contents evaluation results sending page” button (a link button for reading the next page that is associated) on the screen 350 in the FIG. 7 to incorporate the contents evaluation results sending page into his or her own terminal unit.

And the user of the seller side 110 enters the number (contents number) and the contents evaluation results (contents evaluation software output values) of the subject contents, a member ID, a password and so on given on registration in the step S301, and push a “Send” button to send the entered information to the buyer-side server 140 on a screen 360 as shown in FIG. 8 for instance displayed on his or her own terminal unit.

Step S308:

The buyer-side server 140 receives information from the seller side 110, and acquires an evaluated price from the contents evaluation software output values (encrypted output values of the contents evaluation software) included in the received information.

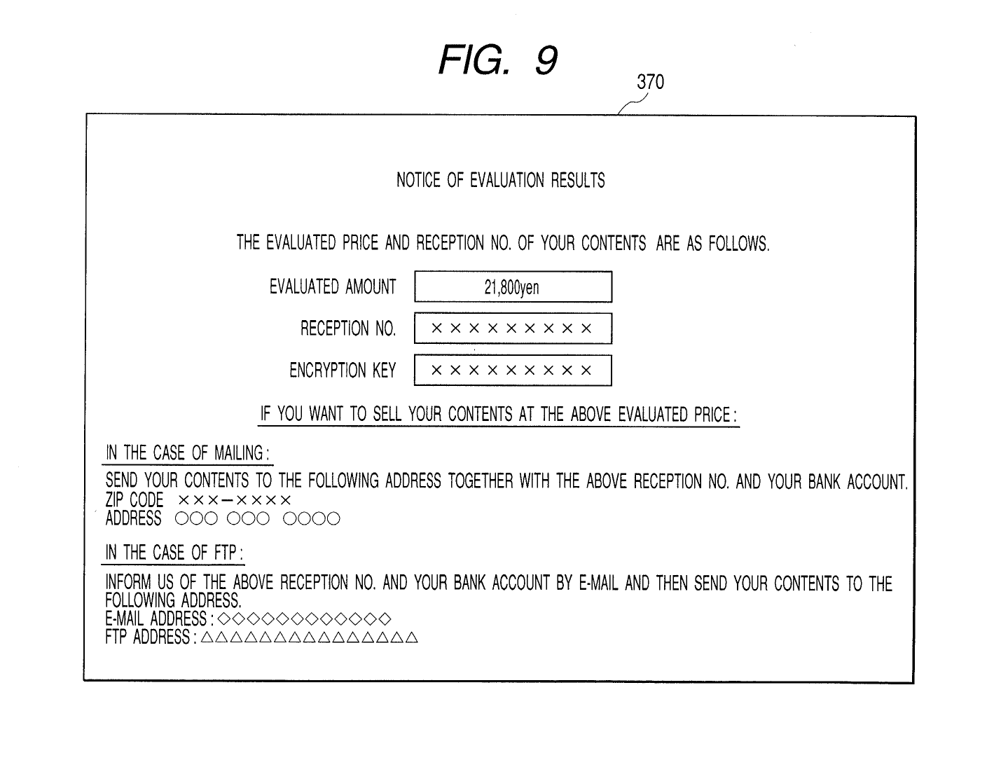

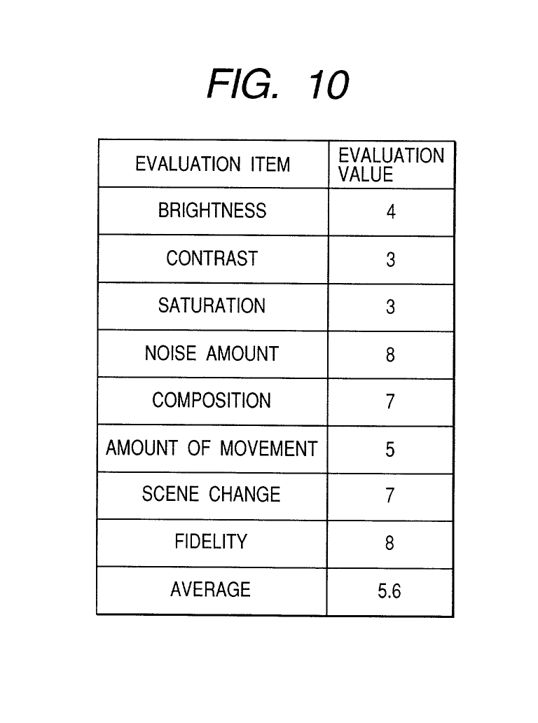

And the buyer-side server 140 sends the evaluated price (evaluated amount), a reception number, a public key for encryption, contents destination information (a destination specified by the buyer side 150) and so on to the WWW browser 120 of the seller side 110 as information on a screen 370 as shown in FIG. 9 for instance so as to present them to the seller side 110.

Moreover, as for timing for disclosing the public key for encryption to the seller side 110, it may be the timing for notifying completion of the membership registration in the step S301 or another timing.

Step S309:

The user of the seller side 110 determines whether or not he or she is convinced of the evaluated amount presented on the screen 370 in the FIG. 9.

As a result of this determination, in the case where the user of the seller side 110 is not convinced of the evaluated amount, he or she terminates this process.

Step S310:

As a result of the determination in the step S309, in the case where the user of the seller side 110 is convinced of the evaluated amount, the user encrypts the contents and FTP-transmits them by his or her own terminal unit to the data storage area (an FTP address specified by the buyer side 150) in the buyer-side server 140 opened to the seller side 110. The key for encryption presented on the screen 370 in the FIG. 9 is used for the encryption at this time.

Moreover, as for the software required for FTP transmission on the seller side 110, general purpose software that is conventionally distributed can be used, or in the case where the terminal unit is not a computer, arbitrary software attached to the unit can be used.

In addition, in the case where the seller side 110 does not want to send the contents via the Internet 130, the contents may be sent to the buyer side 150 by mail according to the mailing information (a zip code and information) presented on the screen 370 as shown in the FIG. 9. Moreover, as for the encryption on the seller side 110 described in detail later, the public key encryption (RSA, elliptical curve cryptography) scheme is used for instance.

Step S311:

The buyer side 150 receives the contents from the seller side 110 via the network 130 or by mail, and checks the contents and then pays the evaluated amount to the seller side 110.

As for a payment method here, a method of paying by transfer to the financial institution side 160 in alliance with the user of the buyer side 150 via the network 130 is suitable.

The above-mentioned is the operation of the electronic commerce system 100 in this embodiment.

Here, the membership registration process in the step S301, the contents evaluation process in the step S306 and the encryption in the step S310 in the above-mentioned operation will be concretely described.

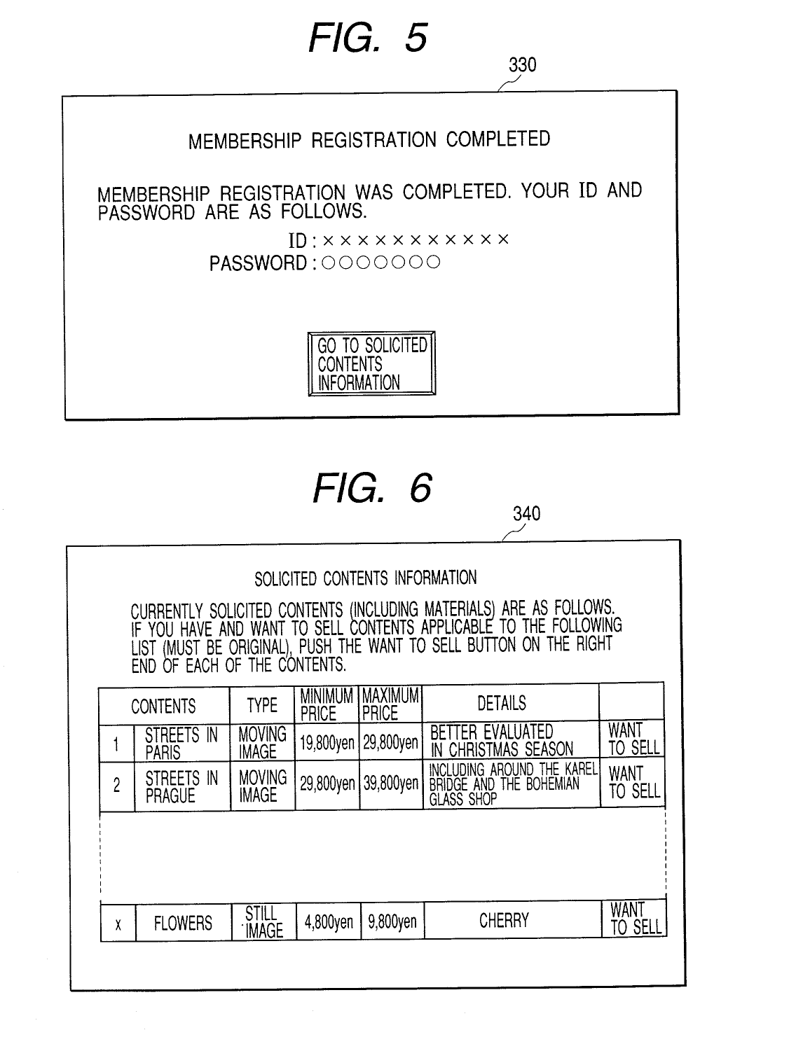

Membership registration process: See FIG. 4 and FIG. 5.

The user of the seller side 110 acquires by using the WWW browser 120 a screen 320 as a data file in the HTML format as shown in FIG. 4, for instance, including a form for membership registration present in the buyer-side server 140 operated and managed by the buyer side 150.

And then, the user of the seller side 110 enters personal information such as his or her name, address, contact and bank account on the screen 320 in the FIG. 4, and pushes the “Send” button to transmit the information to the buyer-side server 140.

The buyer-side server 140 receives the information from the seller side 110, executes the membership registration process based on the received information, and transmits a screen 330 as a data file including the member ID and password information as shown in FIG. 5 for instance to the seller side 110 via the WWW browser 120.

Contents evaluation process: See FIG. 10 For instance, in the case where the subject contents are image sequence data, evaluation items for measuring image sequence data integrity are brightness, contrast, saturation, noise amount and so on. As for the brightness, contrast and saturation, the higher a measured value is, the higher the quality is. And as for the noise, the lower a measured value is, the higher the quality is.

In addition, as for other evaluation items for measuring image sequence data integrity, its composition, amount of movement, number of scene changes and fidelity to a shooting theme and so on are thinkable. As these items have different evaluation criteria according to the type of the image sequence data, proper evaluation criteria are provided to each of the subject contents to make a determination.

In evaluating the image sequence data according to the above-mentioned items, ten-scale evaluation is conducted to take their average, for instance. For instance, in FIG. 10, evaluation of the items of brightness, contrast, saturation, noise amount, composition, amount of movement, number of scene changes and fidelity is performed on the scale of 1 to 10 so as to acquire their average. It is also possible to assign weights to the items at this time.

As for a method of reflecting the evaluation results on the evaluated amount of the contents, there is a following method for instance.

When the average of evaluation values is “5.0” that is a median value, the evaluated amount should also be an amount intermediate between the maximum and minimum amounts. In addition, in the case where the average of evaluation values is a maximum or a minimum, the evaluated amount should also be a maximum or minimum amount. To be more specific, the average of evaluation values should linearly correspond to the evaluated amount.

Or else, in the case where the average of evaluation values is around the median value, the evaluated amount should be fixed at an intermediate amount, and in the case where the average of evaluation values is a maximum or a minimum, the evaluated amount should be a maximum or minimum amount. To be more specific, the average of evaluation values should non-linearly correspond to the evaluated amount.

Moreover, while the case where the subject contents are the image sequence data is described here, in the case where the subject contents are audio (music) data, image and audio data or game software and so on for instance, the evaluation items should also be set in advance for each type of the contents just as in the above-mentioned case of image sequence data, and the evaluation values for each evaluation item should be totaled so that the results are reflected on the evaluated amount.

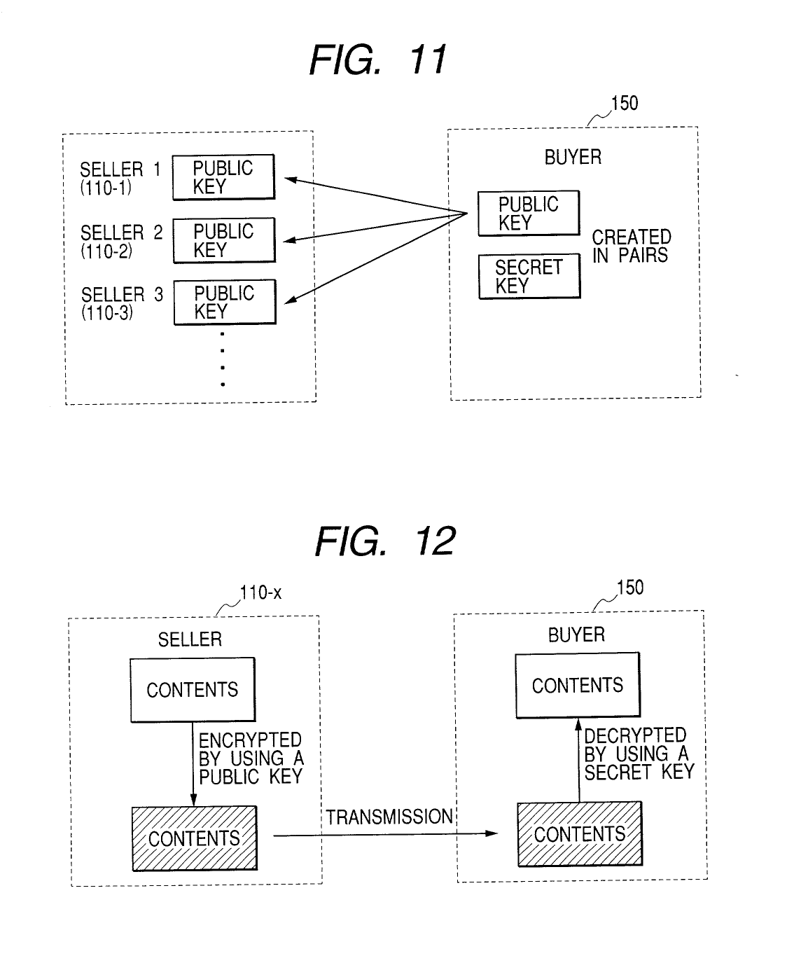

Encryption: See FIG. 11 and FIG. 12

The encryption in this case uses a public key encryption system.

As shown in FIG. 11, a key maker (the buyer side 150 in this case) creates a public key to be released for encryption and a secret key for decryption in a pair, and releases the public key to the encrypting side (in this case, a plurality of sellers, 110-1, 110-2, 110-3, . . . ).

The encrypting side encrypts the contents by using the released key (the encryption key presented on the screen 370 in the FIG. 9) and transmits them as shown in FIG. 12.

The receiving side of the encrypted contents, that is, the key maker uses the secret key created in a pair with the public key to decrypt the encrypted contents.

Such a public key encryption system can decrease the keys to be managed.

### Second Embodiment

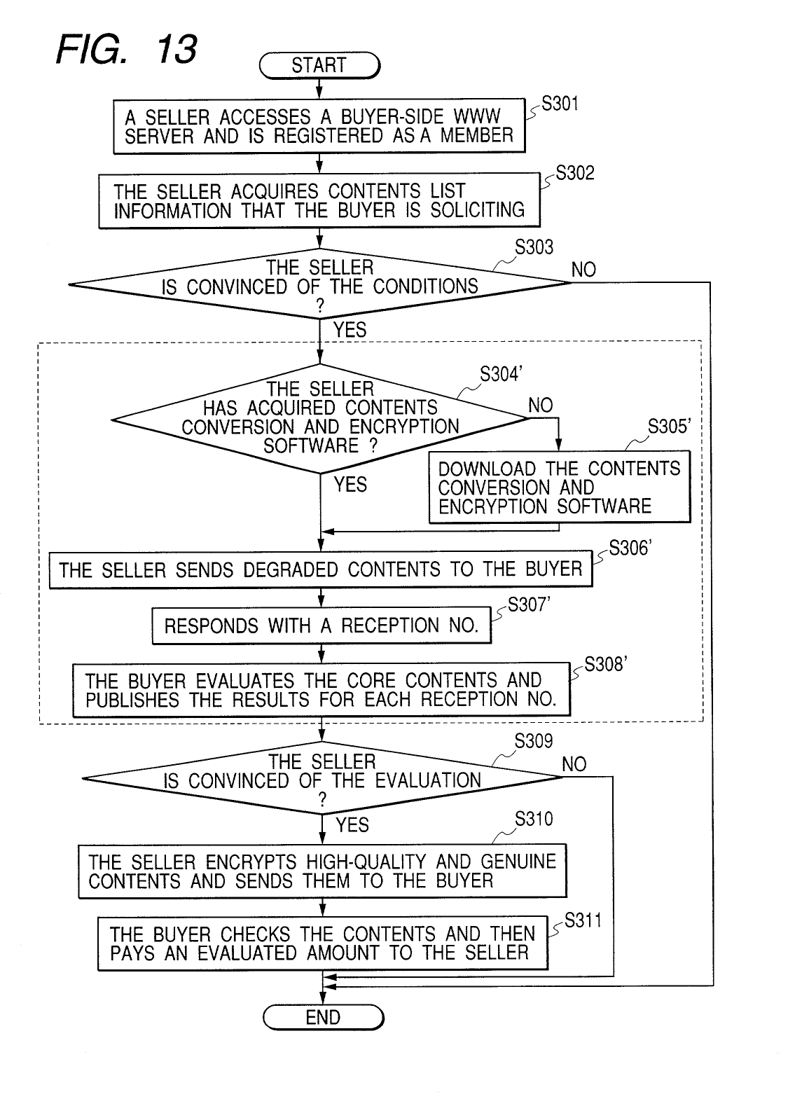

In this embodiment, the operation of the electronic commerce system 100 in the FIG. 1 is the operation according to a flowchart shown in FIG. 13 for instance.

Moreover, in the flowchart of the FIG. 13, the steps performing the same process as in the flowchart of the FIG. 2 are given the same symbols, and detailed description thereof is omitted.

Steps S301 to S303:

The seller side 110 is registered as a member (step S301), and the buyer side 150 acquires solicited contents list information (step S302).

And the seller side 110 performs a process from the next step S304′ in the case where its needs coincide with those of the buyer side 150 (step S303).

Step S304′:

The user of the seller side 110 determines whether or not the contents conversion software for converting his or her own contents to be sold and the contents encryption software have already been acquired. The contents conversion in this case refers to conversion for degrading the subject contents.

As a result of this determination, only in the case where they have not been acquired, the user proceeds to the step S306′ via the next step S305′. In the case where they have been acquired, the user proceeds to the later-mentioned step S306F as-is.

Step S305′:

As a result of the determination of the step S304′, in the case where the contents conversion software and contents encryption software have not been acquired, that is, for instance, in the case where the user of the seller side 110 has not acquired the software since he or she uses the system 100 for the first time or for a similar reason, the user on the seller side 110 downloads the software from the buyer-side server 140 to his or her own terminal unit.

Moreover, as the method of downloading the contents conversion software and the contents encryption software in the step S3051 is the same as the method of downloading the contents evaluation software and the contents encryption software in the first embodiment, detailed description thereof is omitted.

In addition, while the contents conversion process by running the contents conversion software will be described layer, it is also possible to have the process performed by a JAVA applet for instance, rather than by software (application). In this case, it is not required to force the seller side 110 to download and store the contents conversion software. This is effective in the case where there is not enough storage capacity on the terminal unit of the seller side 110 or in the case where the user of the seller side 110 is not accustomed to operation of the terminal unit, and so on.

Step S306′:

The user of the seller side 110 activates the contents conversion software on his or her terminal unit to degrade his or her own contents to be sold, and FTP-transmits or mails them to the buyer side 150. Moreover, the destination information on FTP transmission can be presented to the seller side 110 either on membership registration in the step S301 or in another timing.

Step S307′:

The buyer side 150 receives the converted contents from the seller side 110 as the contents for evaluation, and immediately issues its reception number to the seller side 110.

Step S308′:

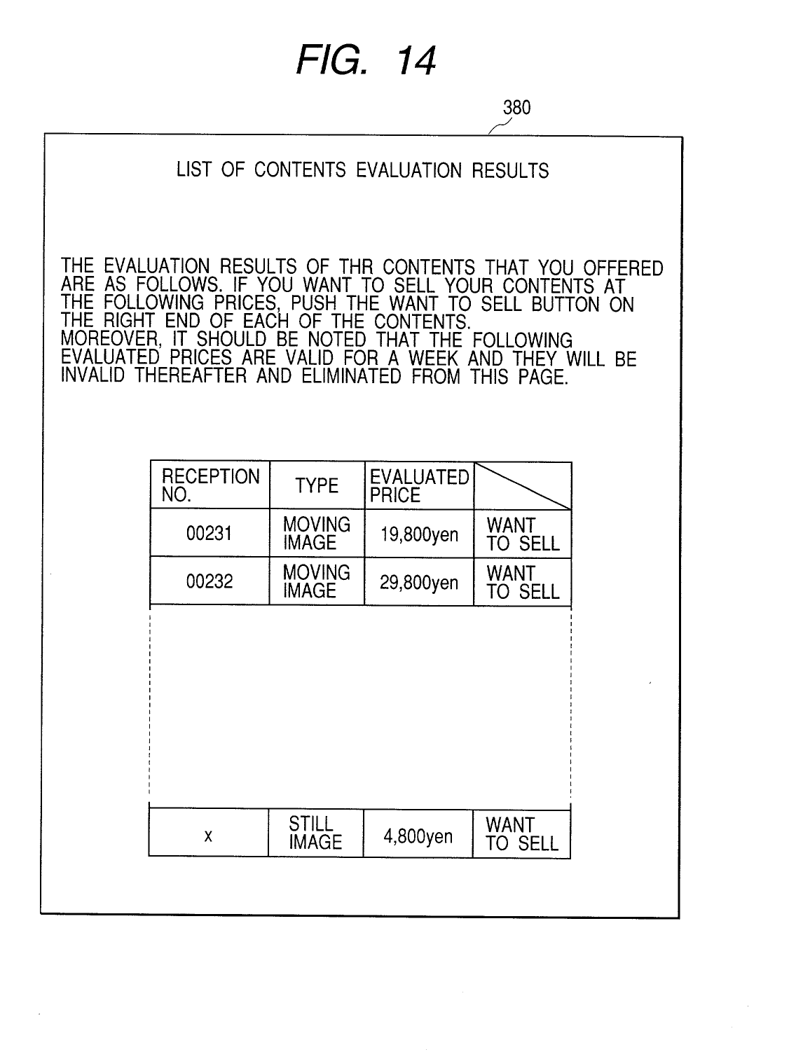

The buyer side 150 evaluates the contents for evaluation by performing the same process as the contents evaluation process in the first embodiment, and sends the consequently acquired information on the evaluated amount to the WWW browser 120 of the seller side 110 as information on the screen 380 as shown in FIG. 14 for instance so as to present it to the seller side 110.

Moreover, in the case where the evaluation contents are sent by mail from the seller side 110, the buyer side 150 evaluates the evaluation contents, and then presents to the seller side 110 the consequently acquired information on the evaluated amount with a reception number attached by mail, e-mail and so on.

Step S309 to S311:

In the case where the seller side 110 is convinced of the evaluated price presented by the buyer side 150 (step S309), it encrypts the subject contents and transmits them to the buyer side 150 (step S310).

The buyer side 150 checks the contents from the seller side 110 and then pays the evaluated price to the seller side 110 (step S311).

Here, the contents conversion process in the above-mentioned step S306′ will be concretely described.

For instance, in the case where the subject contents are image data, a process of down-sampling the images (a thinning process) to decrease an information amount of the images (number of pixels), a process of performing irreversible compression processing such as MPEG (Moving Picture Expert Group) and so on are thinkable as conversion processes for degrading the image data. Both these methods are suitable since they are capable of reducing a transfer amount of image data and also principle-wise incapable of restoring the original images. Of course, any method is suitable as far as it is incapable of restoring the original images.

### Third Embodiment

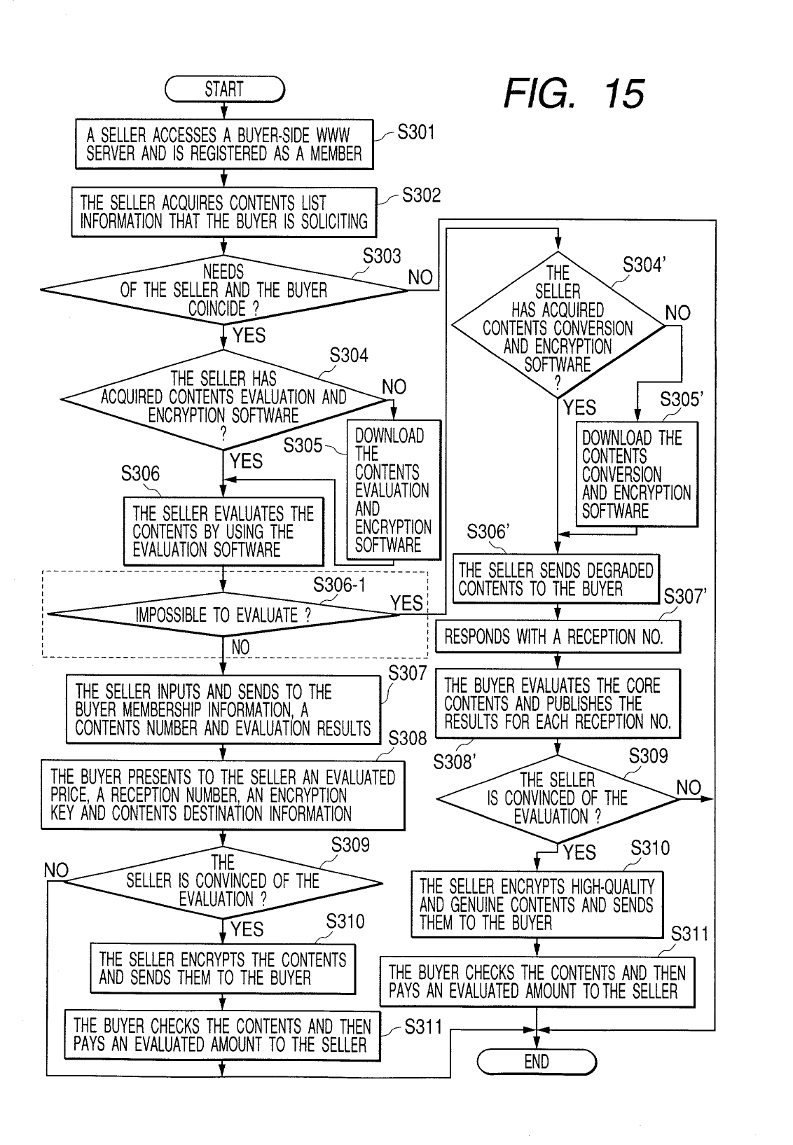

In this embodiment, the operation of the electronic commerce system 100 in the FIG. 1 is the operation according to a flowchart shown in FIG. 15 for instance.

Moreover, in the flowchart of the FIG. 15, the steps performing the same process as in the flowchart of the FIG. 2 and FIG. 13 are given the same symbols, and detailed description thereof is omitted.

Steps S301 to S306:

The seller side 110 is registered as a member (step S301), and acquires contents list information currently solicited by the buyer side 150 (step S302).

And the seller side 110 activates its own contents evaluation software and evaluates its own contents to sell (step S306) in the case where its needs coincide with those of the buyer side 150 (step S303). However, in the case where it has not acquired the contents evaluation software and the contents encryption software at this time (step S304), it downloads the software from the buyer-side server 140 to its own terminal unit (step S305) and uses it for contents evaluation.

Step S306-1:

The user of the seller side 110 determines, as a result of the contents evaluation process in his or her terminal unit, whether or not the contents evaluation process has normally ended.

To be more specific, for instance, the contents evaluation software notifies the user by a message whether or not the contents evaluation process has normally ended.

It allows the user of the seller side 110 to recognize by a message displayed on the screen of his or her terminal unit and so on whether or not the contents evaluation process has normally ended.

As a result of the determination here, in the case where the contents evaluation process has normally ended (in the case where it was possible to automate the contents evaluation process), the process from the next step S307 is executed, and in the case where the contents evaluation process has not normally ended (in the case where it was impossible to automate the contents evaluation process), the process from the later-mentioned step S304′ is executed.

Steps S307 to S311:

As a result of the determination in the step S3061, in the case where it was possible to automate the contents evaluation process, the seller side 110 acquires the contents evaluation results and sends the results (contents evaluation software output values) to the buyer-side server 140 together with the subject contents number (contents number), member ID, password and so on (step S307).

The buyer-side server 140 acquires the evaluated price of the contents based on the information from the seller side 110, and presents the evaluated price to the seller side 110 together with the reception number, public key for encryption and contents destination information (step S308).

In the case where the seller side 110 is convinced of the evaluated price presented by the buyer side 150 (step S309), it encrypts the subject contents and transmits them to the buyer side 150 (step S310).

The buyer side 150 checks the contents from the seller side 110 and then pays the evaluated price to the seller side 110 (step S311).

Steps S304′ to S308′, S309 to S311:

As a result of the determination in the step S3061, in the case where it was impossible to automate the contents evaluation process, the seller side 110 determines whether or not the contents conversion software for degrading the subject contents has already been acquired (step S304′), and in the case where it has not acquired the software, it downloads the software from the buyer-side server 140 to his or her own terminal unit (step S305′).

The seller side 110 activates the contents conversion software on its terminal unit and degrades its own contents to sell, and FTP-transmits or mails them to the buyer side 150 (step S306′).

The seller side 150 receives from the seller side 110 the converted contents as the contents for evaluation, immediately issues its reception number to the seller side 110 (step S307′), and personally evaluates the contents for evaluation and presents the consequently acquired evaluated amount to the seller side 110 (step S308′).

In the case where the seller side 110 is convinced of the evaluated price presented by the buyer side 150 (step S309), it encrypts the subject contents and transmits them to the buyer side 150 (step S310).

The buyer side 150 checks the contents from the seller side 110 and then pays the evaluated price to the seller side 110 (step S311).

<Main points of fourth to sixth embodiments>

First, the main points of the fourth to sixth embodiments will be described.

In the fourth embodiment, the seller side (a user desirous of selling a commercial product) and the buyer side (a user desirous of buying a commercial product) access a home page provided by the broker and request sale of the commercial product. On this home page, information on a buyer-side desired price (a desired buying price) and a price for the broker to accept the commercial product from the seller side (an accepting price) is listed as information for the seller side, and information on a seller-side desired price (a desired selling price) and a price for the broker to sell the commercial product to the buyer side is listed as information for the buyer side.

In this case, the following four commercial forms are assumed, and the fourth embodiment provides electronic commercial product sale brokerage capable of supporting all these commercial forms.

(a) The seller side sells a wait-to-sell commercial product (a commercial product having a user desirous of buying it) via a broker.

(b) The seller side registers a commercial product not wait-to-sell as a commercial product desired to sell (a commercial product having no user desirous of buying it) (sell register).

(c) The buyer side buys a wait-to-buy commercial product (a commercial product having a user desirous of selling it) via a broker.

(d) The buyer side registers that it wants to buy a commercial product not wait-to-buy (a commercial product having no user desirous of selling it) (buy register).

In addition, in the fourth embodiment, the commercial products to be traded are not limited, and commercial product details information provided by the buyer side or the seller side is listed as-is. And the commercial product is distributed only at the stage where there are both the seller side and the buyer side.

The fourth embodiment is most characteristic in the (1) to (5) below.

(1) The seller side can sell whatever the commercial product to sell is.

(2) The seller side can clearly grasp the broker fee.

(3) The buyer side can buy-register whatever commercial product it desires to buy.

(4) The buyer side can clearly grasp the broker fee.

(5) The broker can reduce the risk since it does not actually have stocks of the commercial product.

In the fifth embodiment, the broker limits the commercial products to be traded, and immediately buys a commercial product desired to sell (a desired sell) whether or not it is wait-to-sell. Redundant commercial products in this case are listed as inventories on the home page provided by the broker.

As for a commercial product desired to buy (a desired buy), it is immediately sold to the buyer side in the case where the commercial product is in stock, and is registered as a registered buy on the home page in the case where it is not in stock.

Accordingly, the broker can reduce stocks of the commercial product by dealing only in immediately salable commercial products. In addition, the time it takes until completion of sale of a commercial product can be reduced since it will not depend on the sellerside schedule when scheduling distribution.

The fifth embodiment is most characteristic in the (1) to (5) below.

(1) The seller side can have the commercial product to sell immediately bought whether or not there is a buyer side.

(2) The seller side can clearly grasp the broker fee.

(3) The buyer side can immediately acquire the commercial product in the case it is in stock.

(4) The buyer side can clearly grasp the broker fee.

(5) The broker can improve efficiency of sale since it becomes easier to adjust commercial product distribution.

In the sixth embodiment, the broker limits the commercial products to be traded to the commercial products capable of simple method of sending such as mailing so as to reduce distribution costs. In addition, the price is paid to the seller side after sending the commercial product from the seller side, and the commercial product is sent to the buyer side after receipt of the money from the buyer side is confirmed.

Thus, trade can be securely performed and scheduling of commercial product distribution is no longer necessary, and so the time it takes until completion of sale of the commercial product can be reduced.

The sixth embodiment is most characteristic in the (1) to (6) below.

(1) The seller side can have the commercial product to sell immediately bought whether or not there is a buyer side.

(2) The seller side can clearly grasp the broker fee.

(3) The buyer side can immediately acquire the commercial product in the case it is in stock.

(4) The buyer side can clearly grasp the broker fee.

(5) The broker can securely get the price.

(6) The broker can improve efficiency of sale since it becomes easier to adjust commercial product distribution.

### Fourth Embodiment

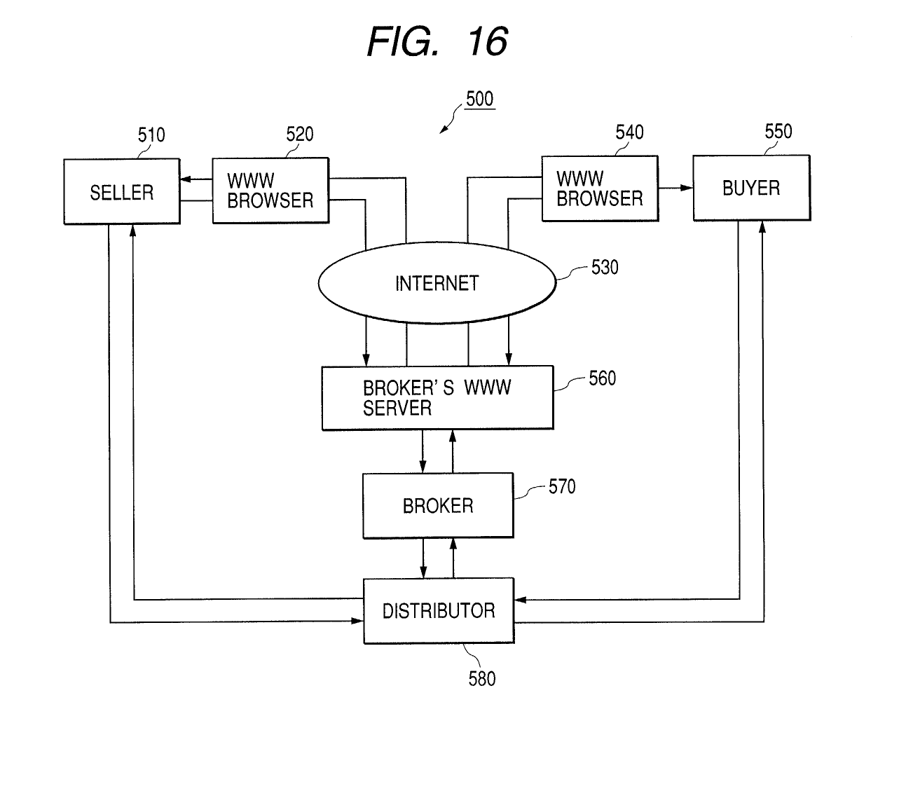

The present invention is applied to an electronic commerce system 500 as shown in FIG. 16 for instance.

(Configuration of the electronic commerce system 500)

As shown in the FIG. 16, the electronic commerce system 500 has a configuration wherein a seller-side terminal unit 510 (hereafter, merely referred to as “seller side 510”), a WWW browser 520 operated and managed from the seller side 510, a buyer-side terminal unit 550 (hereafter, merely referred to as “buyer side 550”), a WWW browser 540 operated and managed from the buyer side 550, and a broker-side terminal unit 570 (hereafter, merely referred to as “broker side 570”) and a WWW server 560 operated and managed from the broker side 570 are mutually connected in a manner capable of communication via a network 530 such as the Internet (the Internet in this case).

Moreover, while the FIG. 16 shows a configuration wherein one each of the seller side 510, the buyer side 550 and the broker side 570 is connected onto the Internet 530 for convenience of description, it is not limited to this number of connections.

The seller side 510, the buyer side 550, the broker side 570 and the WWW server 560 have the functions of the computer 200 having a configuration as shown in FIG. 2 respectively for instance, and the operation of the electronic commerce system 500 in this embodiment is performed by the CPU 201 in the computer 200.

The seller side 510 is on the side of selling commercial products, and includes the terminal unit having functions of the computer 200 shown in FIG. 2 and activates the WWW browser 520 software thereon to trade in the commercial products by communication with the broker side 570 on the Internet 530.

The buyer side 550 is on the side of purchasing the commercial product, and includes the terminal unit having functions of the computer 200 shown in the FIG. 2 and activates the WWW browser 540 software thereon to trade in the commercial product by communication with the broker side 570 on the Internet 530.

The broker side 570 brokers sale of the commercial product held by the seller side 510 to the buyer side 550, and provides commercial product sale information to the seller side 510 and the buyer side 550 by the WWW server 560, and performs such transactions as distribution of the commercial product, collection of the price and payment.

In addition, the broker side 570 requests a distributor 580 to distribute the commercial product. A requesting method in this case can be by telephone, facsimile or e-mail via the Internet 530 for instance. The distributor 580 distributes the commercial product according to the request from the broker side 570. Moreover, depending on a settlement method of the commercial product sale here, it may pay the price to the seller side 510 and collect the price from the buyer side 550.

The WWW browser 520 of the seller side 510 and the WWW browser 540 of the buyer side 550 include client software for running on the terminal units of the seller side 510 and the buyer side 550 respectively, and display the data file, for instance, in an HTML format and so on on the screen thereof in a suitable form, and send and receive the data file.

In addition, the WWW browsers 520 and 540 are optimized browsers having a GUI (Graphic User Interface) and allows users on the seller side 510 and the buyer side 550, for instance, to utilize electronic commerce services even in the case they do not know detailed workings of the electronic commerce services or the WWW server 560 of the broker side 570.

As for the WWW browsers 520 and 540, Netscape Navigator (trademark) of Netscape Communications Corp., Internet Explorer (trademark) of Microsoft Corp. and so on are applicable.

The WWW server 560 of the broker side 570 has the functions of the HTTP (Hyper Text Transfer Protocol) server and the FTP (File Transfer Protocol) server.

In addition, the WWW server 560 includes a server program, and activates the server program to perform services according to a request from the WWW browser 520 and notify results thereof and return the data file (a file in an HTML format and so on) according to the request, or provide e-mail services and so on.

Furthermore, the WWW server 560 stores and updates the data such as commercial product sale brokerage information and distribution schedule information of the distributor 580.

The Internet 530 is a kind of a communication network, and is using a network protocol such as the TCP/IP protocol.

The network protocol in this case provides a standard processing sequence for the terminal units to mutually communicate, and indicates how to format the data in the case of sending and receiving it via the Internet 530, and so on. It allows seamless communication even if the terminal unit of the other party is a different model.

Moreover, HTTP, FTP and SMTP and so on can be named as the standard network protocols. As for the HTTP, it is described in detail in a commercial product of T. Bemers Lee, R. Fieldig and H. Frystyk “Hypertext Transfer Protocol/HTTP/1.0: Sep. 4, 1995” and so on. In addition, the FTP is described in detail in the commercial product of J. B. Postel and J. K. Reynolds “File Transfer Protocol (FTP): RFC959, Information Science Institute, USC, Oct., 1985” and so on. Also, the SMTP is described in detail in the commercial product of J. B. Postel “Simple Mail Transfer Protocol: RFC821, Information Science Institute, USC, Aug., 1982” and so on.

(Operation of the electronic commerce system 500)

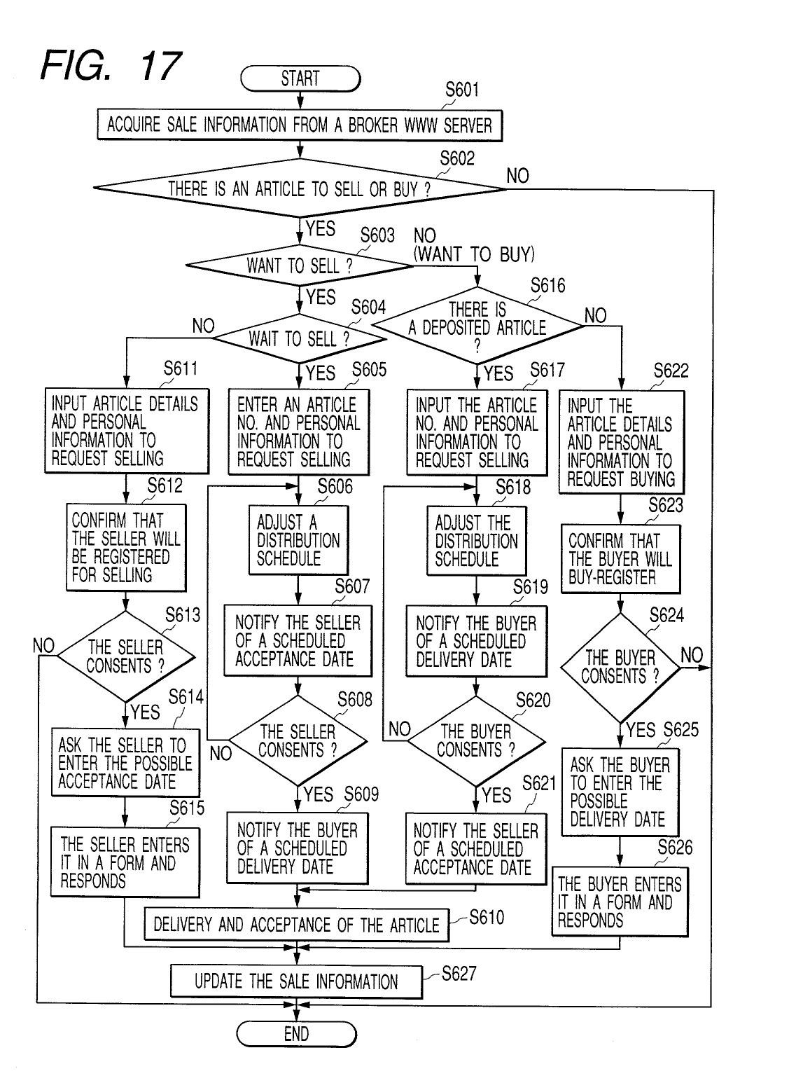

FIG. 17 shows operation of the electronic commerce system 500, and FIG. 17 to FIG. 20 show an example of the concept of the screen in the operation.

Moreover, in the following description, a “page” indicates the display screen on the terminal units of the seller side 510 and the buyer side 550 on which the data files in the HTML format and so on acquired by the operators of the seller side 510 and the buyer side 550 from the WWW server 560 of the broker side 570 by using the corresponding WWW browsers 520 and 540 respectively are screen-displayed.

(1) In the case where the seller side 510 sells the commercial product

Step S601: See FIG. 17.

The user of the seller side 510 operates the WWW browser 520 running on his or her terminal unit and accesses the home page of the broker side 570 specified by a predetermined URL (an address on the Internet).

It is equivalent for the buyer side 510 to acquiring by using the WWW browser 520 the data files in HTML and so on, for instance, including commercial product information in the WWW server 560 managed and operated by the broker side 570.

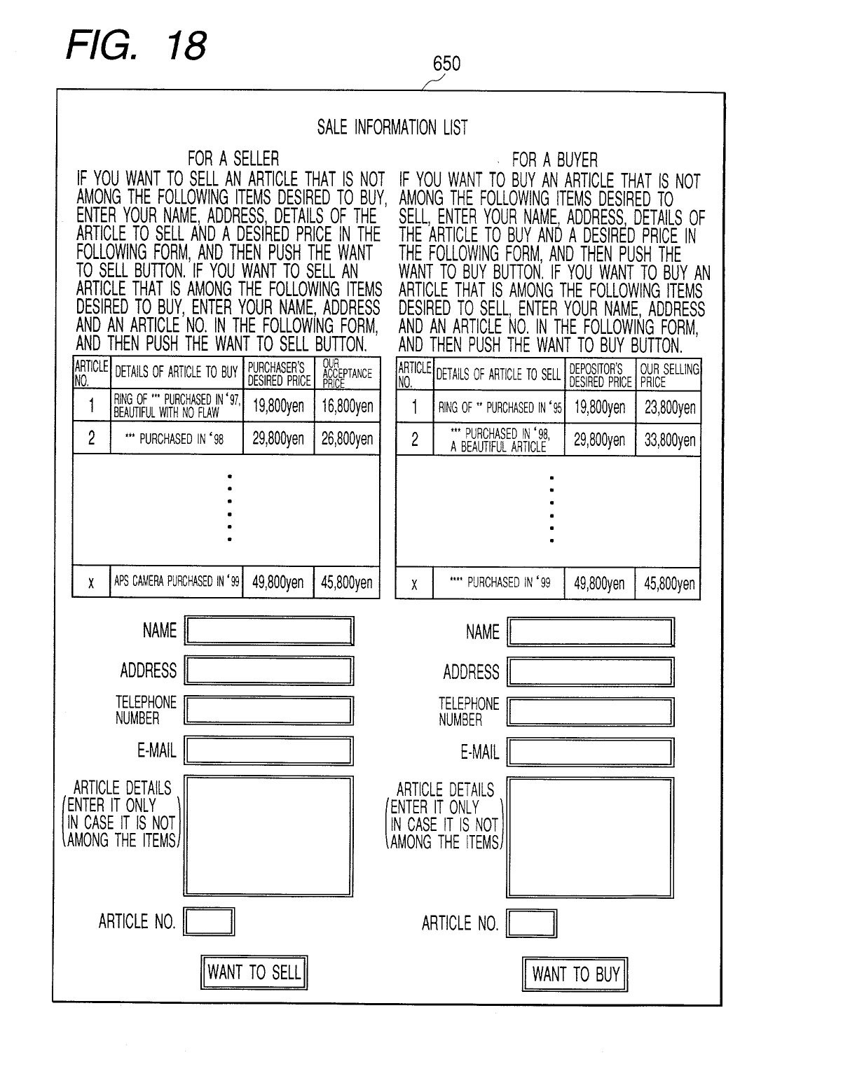

FIG. 18 shows an example of a screen 650 of the home page (sale information list) of the broker side 570 displayed in the step S601 on the screen of the terminal unit of the seller side 510 or the terminal unit of the buyer side 550 mentioned later.

Moreover, the details of price indication on the sale information list screen 650 will be mentioned later.

Step S602 to S604:

Here, as this is the case where the seller side 510 sells a commercial product, it proceeds to the next step S604 via the processes of “There is a commercial product to sell” in the step S602 and “Want to sell” in the next step S603.

The user of the seller side 510 sees the screen 650 in the FIG. 18 (especially sees the information of “For a seller” in the left portion of the screen 650) to check whether there is mention of a buyer side that wants to buy an equivalent of the commercial product that the user wants to sell.

To be more specific, the user of the seller side 510 determines whether or not the commercial product that he or she wants to sell is in a state of wait-to-sell.

As a result of this determination, in the case where it is not in a state of wait-to-sell, the user proceeds to the processes from the step S611 mentioned later.

Step S605:

In “For a seller” on the screen 650 in the FIG. 18, the user of the seller side 510 enters the “name,” “address,” “telephone number,” “electronic mail address (e-mail),” “commercial product number” and personal information such as credit card information depending on the settlement of method mentioned later and pushes the “Want to sell” button to transmit the entered information to the WWW server 560 of the broker side 570 (sending a sell request).

Step S606:

The WWW server 560 of the broker side 570 receives the sell request from the seller side 510 and adjusts the distribution schedule according to the request.

Step S607:

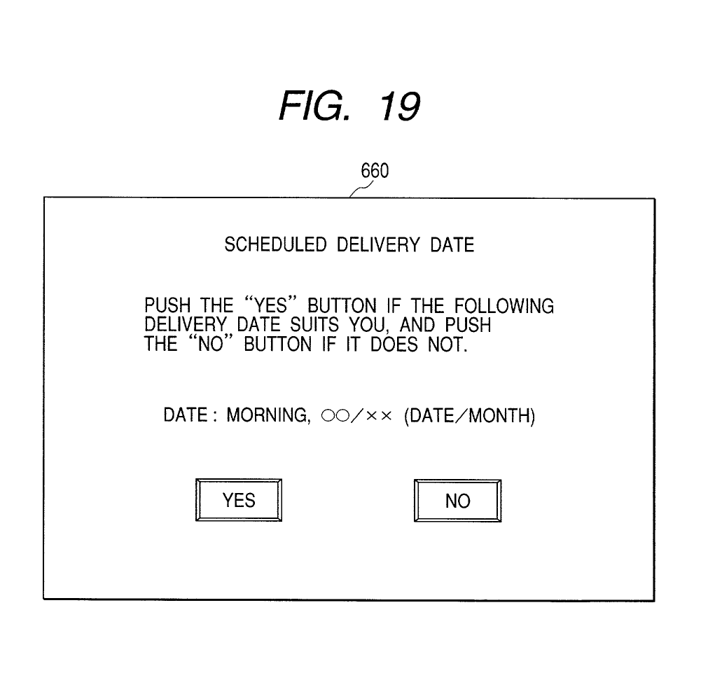

As a result of adjustment of the distribution schedule in the step S606, the WWW server 560 of the broker side 570 sends to the seller side 510 the data file of the screen 660 including the information such as a scheduled delivery date of the commercial product (the delivery date desired by the buyer wanting to buy the commercial product) as shown in FIG. 19.

Thus, the seller side 510 checks the scheduled delivery date on the screen 660 in the FIG. 19, pushes the “Yes” button if the date is convenient and pushes the “No” button if it is not convenient so as to send a notice to the WWW server 560 of the broker side 570 to that effect.

Step S608:

The WWW server 560 of the broker side 570 repeatedly executes the processes of the steps S606 to S608 until the delivery date of the commercial product is determined (until the seller side 510 consents) according to the notice from the seller side 510.

Moreover, exchanges between the WWW server 560 of the broker side 570 and the seller side 510 in the steps S606 to S608 will be described later.

In addition, as for the scheduled delivery date of the commercial product, that is, the delivery date that the buyer side (the buyer side 550 in this case) wanting to buy the commercial product desires is registered in advance, which will be described in detail later.

Step S609:

If the scheduled delivery date of the commercial product is determined in the steps S606 to S608, the WWW server 560 of the broker side 570 sends a notice of the scheduled date to the buyer side 550 by e-mail and so on.

In addition, the broker side 570 also sends a notice of the determined scheduled delivery date to the distributor 580.

Step S610:

The user of the seller side 510 has the commercial product desired to sell distributed to the buyer side 550 by the distributor 580 in alliance with the broker side 570 according to the determined scheduled delivery date.

Thus, the user of the buyer side 550 receives the desired commercial product and pays the price thereafter.

Moreover, the method of paying the price on the buyer side 550 will be mentioned later.

Step S627:

The WWW server 560 of the broker side 570 updates the sale information according to the above-mentioned commercial product trade.

Step S611:

On the other hand, in the above-mentioned step S604, in the case where the commercial product that the seller side 510 wants to sell is not in a state of wait-to-sell, that is, in the case where there is no mention of wait-to-sell (a person wanting to buy exists) as to the commercial product that the seller side 510 wants to sell on the sale information list screen 650 in the FIG. 18, the user of the seller side 510 enters the “name,” “address,” “telephone number,” “electronic mail address (e-mail),” “commercial product number” and personal information such as credit card information depending on the settlement of method mentioned later as well as “commercial product details” and pushes the “Want to buy” button to transmit the entered information to the WWW server 560 of the broker side 570 (sending a sell request).

Step S612:

The WWW server 560 of the broker side 570 receives the sell request from the seller side 510 and sends to the seller side 510 the data file for checking whether or not to sell-register the commercial product shown by the request.

Thus, the seller side 510 sends a notice to the WWW server 560 of the broker side 570 as to whether or not it wants to sell-register.

Step S613:

The WWW server 560 of the broker side 570 determines from the notice from the seller side 510 whether or not the seller side 510 has consented to sell-register, and it executes the process from the next step S614 in the case where the seller side 510 has consented to sell-register, and it terminates the process in the case where the seller side 510 has not consented.

Step S614:

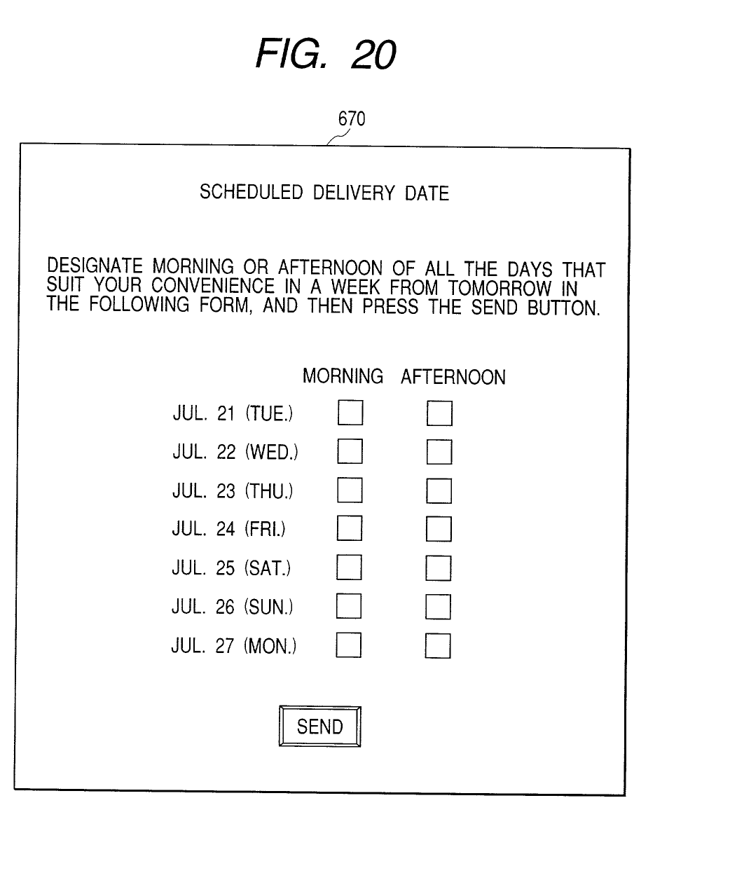

The WWW server 560 of the broker side 570 sends to the seller side 510 the data file of the screen 670 for entering a possible delivery date of the commercial product as shown in FIG. 20 for instance.

Step S615:

The seller side 510 enters the possible delivery date of the commercial product on the screen 670 in FIG. 20, and responds with this entered information to the WWW server 560 of the broker side 570.

Step S627:

The WWW server 560 of the broker side 570 updates the sale information according to the responded information from the seller side 510.

(2) Cases where the buyer side 550 buys a commercial product

Step S601: See FIG. 17.

The user of the buyer side 550 operates the WWW browser 540 running on his or her terminal unit and accesses the home page of the broker side 570 indicated by a predetermined URL (an address on the Internet).

It is equivalent for the buyer side 550 to acquiring by using the WWW browser 540 the data files in HTML and so on, for instance, including commercial product information in the WWW server 560 managed and operated by the broker side 570.

Step S602, S603 and S616:

Here, as this is the case where the buyer side 550 buys a commercial product, it proceeds to the next step S616 via the processes of “There is a commercial product to buy” in the step S602 and “Want to buy” in the next step S603.

The user of the buyer side 550 sees the screen 650 in the FIG. 18 (especially sees the information of “For a buyer” in the right portion of the screen 650) to check whether there is a mention of a seller side that wants to sell an equivalent of the commercial product that the user wants to buy.

To be more specific, the user of the buyer side 550 determines whether or not there is an equivalent of the commercial product that he or she wants to buy (deposited commercial product).

As a result of this determination, in the case where there is no deposited commercial product, the user proceeds to the processes from the step S622 mentioned later.

Step S617:

In “For a buyer” on the screen 650 in the FIG. 18, the user of the buyer side 550 enters the “name,” “address,” “telephone number,” “electronic mail address (e-mail),” “commercial product number” and personal information such as credit card information depending on the settlement of method mentioned later and pushes the “Want to buy” button to transmit the entered information to the WWW server 560 of the broker side 570 (sending a buy request).

Step S618:

The WWW server 560 of the broker side 570 receives the buy request from the buyer side 550 and adjusts the distribution schedule according to the request.

Step S619:

As a result of adjustment of the distribution schedule in the step S618, the WWW server 560 of the broker side 570 sends to the buyer side 550 the data file of the screen 660 including the information such as a scheduled delivery date of the commercial product (the delivery date desired by the seller wanting to sell the commercial product) as shown in FIG. 19.

Thus, the buyer side 550 checks the scheduled delivery date on the screen 660 in the FIG. 19, pushes the “Yes” button if the date is convenient and pushes the “No” button if it is not convenient so as to send a notice to the WWW server 560 of the broker side 570 to that effect.

Step S620:

The WWW server 560 of the broker side 570 repeatedly executes the processes of the steps S618 to S620 until the delivery date of the commercial product is determined (until the buyer side 550 consents) according to the notice from the buyer side 550.

Moreover, the exchanges between the broker side 570 and the buyer side 550 in this case are the same as those between the broker side 570 and the seller side 510 in the steps S606 to S608.

Step S621:

If the scheduled delivery date of the commercial product is determined in the steps S618 to S620, the WWW server 560 of the broker side 570 sends a notice of the scheduled date to the seller side 510 by e-mail and so on.

In addition, the broker side 570 also sends a notice of the delivery of the commercial product to the distributor 580.

Step S610:

The user of the seller side 510 has the commercial product desired to sell distributed to the buyer side 550 by the distributor 580 in alliance with the broker side 570 according to the determined scheduled delivery date.

Thus, the user of the buyer side 550 receives the desired commercial product and pays the price thereafter.

Moreover, the method of paying the price on the buyer side 550 is as mentioned above.

Step S627:

The WWW server 560 of the broker side 570 updates the sale information according to the above-mentioned commercial product trade.

Step S622:

On the other hand, in the above-mentioned step S616, in the case where there is no mention of a seller side wanting to sell an equivalent of the commercial product that the buyer side 550 wants to buy on the sale information list screen 650 in the FIG. 18, the user of the buyer side 550 enters in “For a buyer” on the screen 650 in the FIG. 18 the “name,” “address,” “telephone number,” “electronic mail address (e-mail),” “commercial product number” and personal information such as credit card information depending on the settlement of method mentioned later as well as “commercial product details” and pushes the “Want to buy” button to transmit the entered information to the WWW server 560 of the broker side 570 (sending a buy request).

Step S623:

The WWW server 560 of the broker side 570 receives the sell request from the buyer side 550 and sends to the buyer side 550 the data file for checking whether or not to buy-register the commercial product shown by the request. Thus, the buyer side 550 sends a notice to the WWW server 560 of the broker side 570 as to whether or not it wants to buy-register.

Step S624:

The WWW server 560 of the broker side 570 determines from the notice from the buyer side 550 whether or not the buyer side 550 has consented to buy-register, and it executes the process from the next step S625 in the case where the buyer side 550 has consented to buy-register, and it terminates the process in the case where the buyer side 550 has not consented.

Step S625:

The WWW server 560 of the broker side 570 sends to the buyer side 550 the data file of the screen 670 for entering a possible delivery date of the commercial product as shown in the FIG. 20 for instance.

Step S626:

The buyer side 550 enters the possible delivery date of the commercial product on the screen 670 in FIG. 20, and responds with the entered information to the WWW server 560 of the broker side 570.

Step S627:

The WWW server 560 of the broker side 570 updates the sale information according to the responded information from the buyer side 550.

Here, the price indication on the sale information list screen 650 in the FIG. 18, the exchanges for determining the scheduled delivery date between the seller side 510 and the broker side 570, and the payment method of the buyer side 550 will be concretely described.

Price indication on the sale information list screen 650 in the FIG. 18 Both the price when actually sold to the buyer side 550 (hereafter referred to as “CP”) and the price when accepted (deposited) by the broker side 570 from the seller side 510 (hereafter referred to as “MPS”) are listed on the sale information list screen 650 in this embodiment.

Moreover, both the desired selling price of the seller side 510 (hereafter referred to as “SP”) and the price when sold by the broker side 570 to the buyer side 550 (hereafter referred to as “MPC”) are listed on the sale information list screen 650.

For instance, as profit of the broker side 570 is added on top in both the cases of selling a commercial product and buying a commercial product, the following inequalities hold.

CP>MPS . . . (1)

SP<MPC . . . (2)

Accordingly, the buyer side 550 buys the commercial product sold by the seller side 510 at a price (CP) higher than the price (MPS) at which the broker side 570 accepted it from the seller side 510, and the seller side 510 delivers the commercial product at a price (MPS) lower than the price (MPC) at which the broker side 570 sells it to the buyer side 550.

As the above-mentioned CP, MPS, SP, and MPC are simultaneously listed on the sale information list screen 650, the seller side 510 and the buyer side 550 can easily recognize information as to how much a margin for the broker side 570 is. In addition, the seller side 510 can easily check whether or not the commercial product it sells is actually listed at the selling price (SP) actually desired, and the buyer side 550 can also easily check whether or not its desired buying price (CP) is actually listed.

For this reason, it can make the trade sound by securely preventing the broker side 570 from acquiring an undue margin and gives feeling of security to the seller side 510 and the buyer side 550 as to the trade.

Exchanges for determining the scheduled delivery date between the broker side 570 and the seller side 510 (see the steps S606 to S608 in the FIG. 17)

As a method of determining the date, there is a method of presenting the scheduled date from the broker side 570 to the seller side 510 by the screen 660 in the FIG. 19 and answering thereto from the seller side 510.

In addition, there is a method of having a convenient date for the seller side 510 selected on the screen 670 in FIG. 20 so that the broker side 570 will adjust the date so selected. Moreover, as the date desired by the buyer side 550 will be registered in advance, the process for determining the date will be executed in consideration thereof.

As the method of paying the price on the buyer side 550 can be the following (1) to (4) for instance.

(1) When the distributor 580 accepts the commercial product from the seller side 510, it pays the desired price (the accepting price on the broker side 570 listed on the screen 650 in the FIG. 18) to the seller side 510, and collects the price from the buyer side 550 by credit card settlement. In this case, information such as a credit card number is submitted by the buyer side 550 in advance as part of the personal information.

(2) The broker side 570 pays the price for the commercial product to the seller side 510 by transfer to the financial institution and collects the price from the buyer side 550 by credit card settlement.

(3) When the distributor 580 accepts the commercial product from the seller side 510, it pays the desired price (the accepting price on the broker side 570 listed on the screen 650 in the FIG. 18) to the seller side 510, and collects the desired price of the buyer side 550 (the desired price on the buyer side 550 listed on screen 650 in the FIG. 18) when delivering the commercial product to the buyer side 550, and pays profit of the difference to the broker side 570.

In addition, as for the payment from the broker side 570 to the distributor 580 concerning the distribution, the broker side 570 may pay it collectively by month according to distribution man-hours, or pay it separately when the distributor 580 pays the profit of the difference to the broker side 570.

(4) After the commercial product is distributed from the seller side 510 to the buyer side 559, the broker side 570 that has collected the price from the buyer side 550 by the transfer to the financial institution pays the desired price to the seller side 510 by the transfer to the financial institution.

The above-mentioned is configuration and operation of the electronic commerce system 500 in this embodiment.

The processes executed on the WWW server 560 of the broker side 570 in this embodiment can be summarized into the four cases of 1) to 4) as follows.

Case 1) In the case where there is an arbitrary commercial product that the seller side 510 desires to sell and there is the buyer side 550 that desires to buy the commercial product.

(a) Have personal information and the commercial product No. entered on the screen 650 in the FIG. 18 and sent by the seller side 510.

(b) Determine the delivery date of the commercial product by sending and receiving the data file to and from the seller side 510.

(c) Notify the buyer side 550 of the delivery date that is the same as the delivery date.

(d) Request the distributor 580 to distribute the commercial product.

(e) Update the sale information.

Case 2) In the case where there is an arbitrary commercial product that the seller side 510 desires to sell and there is no buyer side 550 that desires to buy the commercial product.

(f) Have personal information and detailed information on the commercial product entered on the screen 650 in the FIG. 18 and sent by the seller side 510.

(g) Check whether or not the seller side 510 sell-registers.

(h) Have the possible delivery date sent to the seller side 510.

(i) Update the sale information.

Case 3) In the case where there is an arbitrary commercial product that the buyer side 550 desires to buy and there is the seller side 510 that desires to sell the commercial product.

(j) Have personal information and the commercial product No. entered on the screen 650 in the FIG. 18 and sent by the buyer side 550.

(k) Determine the delivery date of the commercial product by sending and receiving the data file to and from the buyer side 550.

(l) Notify the seller side 510 of the delivery date that is the same as the delivery date.

(m) Request the distributor 580 to distribute the commercial product.

(n) Update the sale information.

Case 4) In the case where there is an arbitrary commercial product that the buyer side 550 desires to buy and there is no seller side 510 that desires to sell the commercial product.

(o) Have personal information and detailed information on the commercial product entered on the screen 650 in the FIG. 18 and sent by the buyer side 550.

(p) Check whether or not the buyer side 550 buy-registers.

(q) Have the possible delivery date sent by the buyer side 550.

(r) Update the sale information.

### Fifth Embodiment

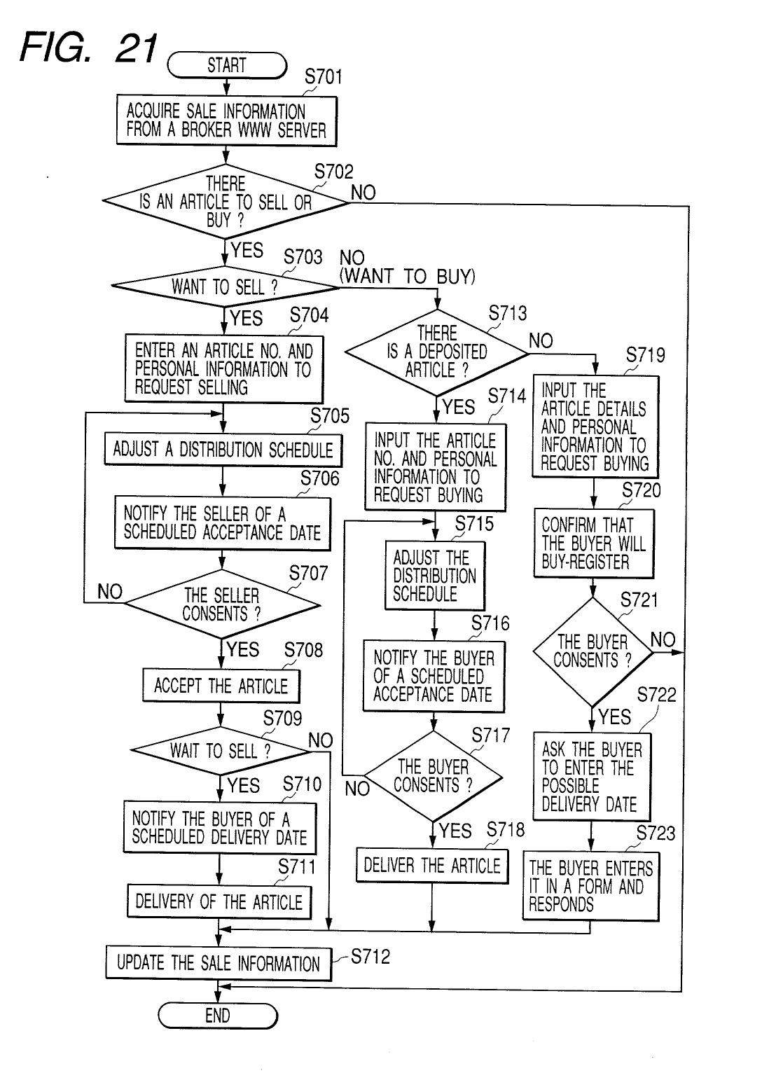

In this embodiment, the operation of the electronic commerce system 500 in the FIG. 16 is the operation according to a flowchart shown in FIG. 21 for instance.

(1) In the case where the seller side 510 sells the commercial product

Step S701:

The user of the seller side 510 operates the WWW browser 520 running on his or her terminal unit and accesses the home page of the broker side 570 indicated by a predetermined URL (an address on the Internet).

It is equivalent for the seller side 510 to acquiring by using the WWW browser 520 the data files in HTML and so on, for instance, including commercial product information in the WWW server 560 managed and operated by the broker side 570.

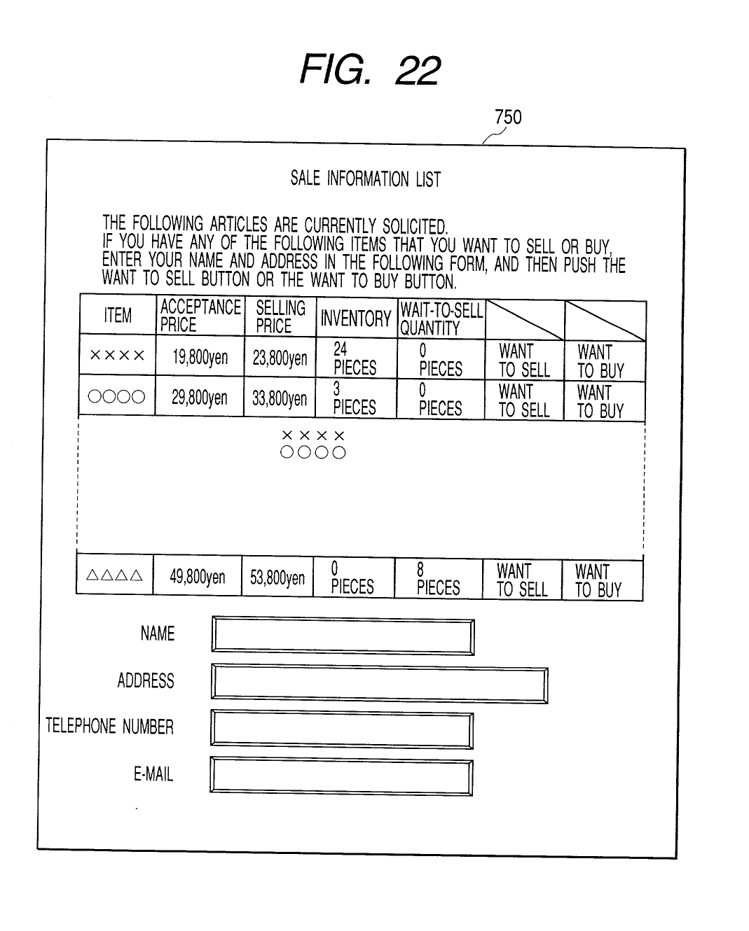

FIG. 22 shows an example of a screen 750 of the home page (sale information list) of the broker side 570 displayed in the step S701 on the screen of the terminal unit of the seller side 510 or the terminal unit of the buyer side 550 mentioned later.

In this embodiment, as shown in the sale information on the screen 750 in the FIG. 22, the commercial products to be traded are limited by the broker side 570. For this reason, the seller side 510 can sell the commercial product only in the case where the commercial product that it desires to sell is listed on the sale information list.

Moreover, details of the price indication on the sale information list screen 750 will be mentioned later.

Step S702 to S704:

Here, as this is the case where the seller side 510 sells a commercial product, it proceeds to the next step S704 via the processes of “There is a commercial product to sell” in the step S702 and “Want to sell” in the next step S703.

The user of the seller side 510 sees the screen 750 in the FIG. 22, checks whether or not an equivalent of the commercial product that the user wants to sell is listed on the sale information list, and if it is listed, he or she enters personal information such as the “name,” “address,” “telephone number” and “electronic mail address (e-mail),” and pushes the “Want to sell” button of the applicable commercial product information box to transmit the entered information to the WWW server 560 of the broker side 570 (sending a sell request).

Moreover, while this embodiment has a configuration wherein the commercial product is specified by pushing the “Want to sell” button in the applicable commercial product information box on the screen 750 in the FIG. 22, it is also feasible to enter the number indicating the commercial product (a commercial product number) directly just as in the fourth embodiment.

Step S705:

The WWW server 560 of the broker side 570 receives the sell request from the seller side 510 and adjusts the distribution schedule according to the request.

Step S706:

As a result of adjustment of the distribution schedule in the step S606, the WWW server 560 of the broker side 570 sends to the seller side 510 the data file of the screen 660 including the information such as a scheduled delivery date of the commercial product (the delivery date desired by the buyer wanting to buy the commercial product) as shown in FIG. 19.

Thus, the seller side 510 checks the scheduled delivery date of the commercial product on the screen 660 in the FIG. 19, and pushes the “Yes” button if the date is convenient and pushes the “No” button if it is not convenient so as to send a notice to the WWW server 560 of the broker side 570 to that effect.

Step S707:

The WWW server 560 of the broker side 570 repeatedly executes the processes of the steps S705 to S707 until the delivery date of the commercial product is determined (until the seller side 510 consents) according to the notice from the seller side 510.

Moreover, exchanges between the WWW server 560 of the broker side 570 and the seller side 510 in the steps S705 to S707 are the same as the exchanges in the fourth embodiment.

In addition, as for the scheduled delivery date of the commercial product, that is, the delivery date that the buyer side (the buyer side 550 in this case) wanting to buy the commercial product desires is registered in advance as in the fourth embodiment.

Step S708:

If the scheduled delivery date of the commercial product is determined in the steps S705 to S707, the WWW server 560 of the broker side 570 sends a notice of the delivery of the commercial product to the distributor 580.

The distributor 580 distributes the commercial product from the seller side 510 to the broker side 570 according to the scheduled delivery date notified by the broker side 570.

Step S709:

The WWW server 560 of the broker side 570 determines whether or not the commercial product that was distributed in the step S708 is in a state of wait-to-sell (whether or not there is a buyer wanting to buy the commercial product).

As a result of this determination, in the case where it is not in a state of wait-to-sell, it proceeds to the process S712 mentioned later.

Step S710:

The WWW server 560 of the broker side 570 determines the scheduled delivery date of the commercial product distributed in the step S708 to the buyer side (the buyer side 550 in this case) that is in a state of wait-to-sell as to the commercial product in consideration of the scheduled delivery date thereof registered in advance, and sends a notice thereof to the buyer side 550 by e-mail and so on.

In addition, the WWW server 560 of the broker side 570 also sends a notice of the determined scheduled delivery date to the distributor 580.

Step S711:

The distributor 580 distributes the commercial product to the buyer side 550 according to the delivery date notified by the broker side 570.

Thus, the user of the buyer side 550 receives the desired commercial product and pays the price thereafter.

Moreover, the method of paying the price on the buyer side 550 will be mentioned later.

Step S712:

The WWW server 560 of the broker side 570 updates the sale information according to the commercial product trade.

(2) Cases where the buyer side 550 buys a commercial product

Step S701: See FIG. 21.

The user of the buyer side 550 operates the WWW browser 540 running on his or her terminal unit and accesses the home page of the broker side 570 indicated by a predetermined URL (an address on the Internet).

It is equivalent for the buyer side 550 to acquiring by using the WWW browser 540 the data files in HTML and so on, for instance, including commercial product information in the WWW server 560 managed and operated by the broker side 570.

Step S702, S703 and S713:

Here, as this is the case where the buyer side 550 buys a commercial product, it proceeds to the next step S713 via the processes of “There is a commercial product to buy” in the step S702 and “Want to buy” in the next step S703.

The user of the buyer side 550 sees the screen 750 in the FIG. 22 to check whether there is an equivalent of the commercial product that the user wants to buy (whether or not there is a deposited commercial product).

As a result of this determination, in the case where there is no deposited commercial product, the user proceeds to the processes from the step S719 mentioned later.

Step S714:

The user of the buyer side 550 enters on the screen 750 in the FIG. 22 personal information such as the “name,” “address,” “telephone number” and “electronic mail address (e-mail)” and pushes the “Want to buy” button of the applicable commercial product information box to transmit the entered information to the WWW server 560 of the broker side 570 (sending a buy request).

Moreover, while this embodiment has a configuration wherein the commercial product is specified by pushing the “Want to sell” button in the applicable commercial product information box on the screen 750 in the FIG. 22, it is also feasible, for instance, to enter the number indicating the commercial product (a commercial product number) directly just as in the fourth embodiment.

Step S715:

The WWW server 560 of the broker side 570 receives the buy request from the buyer side 550 and adjusts the distribution schedule according to the request.

Step S716:

As a result of adjustment of the distribution schedule in the step S715, the WWW server 560 of the broker side 570 sends to the buyer side 550 the data file of the screen 660 including the information such as a scheduled delivery date of the commercial product (the delivery date desired by the seller wanting to sell the commercial product) as shown in FIG. 19.

Thus, the buyer side 550 checks the scheduled delivery date of the commercial product on the screen 660 in the FIG. 19, and pushes the “Yes” button if the date is convenient and pushes the “No” button if it is not convenient so as to send a notice to the WWW server 560 of the broker side 570 to that effect.

Step S717:

The WWW server 560 of the broker side 570 repeatedly executes the processes of the steps S715 to S717 until the delivery date of the commercial product is determined (until the buyer side 550 consents) according to the notice from the buyer side 550.

Moreover, the exchanges between the broker side 570 and the buyer side 550 in this case are the same as the exchanges in the fourth embodiment.

Step S718:

If the scheduled delivery date of the commercial product is determined in the steps S715 to S717, the WWW server 560 of the broker side 570 sends a notice of the scheduled delivery date to the distributor 580.

The distributor 580 distributes the commercial product to the buyer side 550 according to the scheduled delivery date notified by the broker side 570.

Thus, the user of the buyer side 550 receives the desired commercial product and pays the price thereafter.

Moreover, the method of paying the price on the buyer side 550 will be mentioned later.

Step S712:

The WWW server 560 of the broker side 570 updates the sale information according to the commercial product trade.

Step S719:

On the other hand, in the above-mentioned step S713, in the case where there is no equivalent of the commercial product that the buyer side 550 wants to buy listed on the sale information list screen 750 in the FIG. 22, the user of the buyer side 550 enters on the screen 750 in the FIG. 22 personal information such as the “name,” “address,” “telephone number” and “electronic mail address (e-mail)” as well as detailed information on the commercial product and transmits the entered information to the WWW server 560 of the broker side 570 (sending a buy request).

Step S720:

The WWW server 560 of the broker side 570 receives the buy request from the buyer side 550 and sends to the buyer side 550 the data file for checking whether or not to buy-register the commercial product shown by the request. Thus, the buyer side 550 sends a notice to the WWW server 560 of the broker side 570 as to whether or not it wants to buy-register.

Step S721:

The WWW server 560 of the broker side 570 determines from the notice from the buyer side 550 whether or not the buyer side 550 has consented to buy-register, and it executes the process from the next step S722 in the case where the buyer side 550 has consented to buy-register, and it terminates the process in the case where the buyer side 550 has not consented.

Step S722:

The WWW server 560 of the broker side 570 sends to the buyer side 550 the data file of the screen 670 for entering a possible delivery date of the commercial product as shown in the FIG. 20 for instance.

Step S723:

The buyer side 550 enters the possible delivery date of the commercial product on the screen 670 in FIG. 20, and responds with the entered information to the WWW server 560 of the broker side 570.

Step S712:

The WWW server 560 of the broker side 570 updates the sale information according to the responded information from the buyer side 550.

Here, the price indication on the sale information list screen 750 in the FIG. 22 and the payment method of the buyer side 550 will be concretely described.

Price indication on the sale information list screen 750 in the FIG. 22

Both the price when actually sold to the buyer side 550 (CP) and the price when accepted (deposited) by the broker side 570 from the seller side 510 (MPS) are listed on the sale information list screen 750. In this case, as profit of the broker side 570 is added on top, the following inequality represented in the equation (1) holds as in the fourth embodiment.

Accordingly, the buyer side 550 buys the commercial product at a price higher than the price at which the broker side 570 accepted it from the seller side 510.

As the above-mentioned CP and MPS are simultaneously listed on the sale information list screen 750, the seller side 510 and the buyer side 550 can easily recognize information as to how much the intermediate margin for the broker side 570 is. In addition, the seller side 510 can easily check whether or not the price (CP) at which it has actually delivered the commercial product to the broker side 570 is actually listed.

For this reason, it can make the trade sound by securely preventing the broker side 570 from acquiring an undue margin and gives feeling of security to the seller side 510 and the buyer side 550 as to the trade.

Method of paying the price on the buyer side 550

As for the method of paying the price, it can be the following (1) or (2) for instance.

(1) When the distributor 580 accepts the commercial product from the seller side 510, it pays the desired price (the accepting price on the broker side 570 listed on the screen 750 in the FIG. 22) to the seller side 510, and collects the price from the buyer side 550 by credit card settlement. In this case, information such as a credit card number is submitted by the buyer side 550 in advance as part of the personal information.

(2) The broker side 570 pays the price for the commercial product to the seller side 510 by transfer to the financial institution and collects the price from the buyer side 550 by credit card settlement.

The above-mentioned is configuration and operation of the electronic commerce system 500 in this embodiment.

The processes executed on the WWW server 560 of the broker side 570 in this embodiment can be summarized into the three cases of 1) to 3) as follows.

Case 1) In the case where there is the commercial product that the seller side 510 desires to sell among the commercial products limited by the broker side 570.

(a) Have the personal information and the commercial product No. entered on the screen 750 in the FIG. 22 and sent by the seller side 510.

(b) Determine the delivery date of the commercial product by sending and receiving the data file to and from the seller side 510.

(c) Notify the buyer side 550 of the delivery date

(d) Request the distributor 580 to distribute the commercial product.

(e) Update the sale information.

Case 2) In the case where there is the commercial product that the buyer side 550 desires to buy among the commercial products limited by the broker side 570.

(f) Have the personal information and the commercial product number entered on the screen 750 in the FIG. 22 and sent by the buyer side 550.

(g) Determine the delivery date of the commercial product by sending and receiving the data file to and from the buyer side 550.

(h) Request the distributor 580 to distribute the commercial product.

(i) Update the sale information.

Case 3) In the case where there is no commercial product that the buyer side 550 desires to buy among the commercial products limited by the broker side 570.

(j) Have the personal information and detailed information on the commercial product entered on the screen 750 in the FIG. 22 and sent by the buyer side 550.

(k) Check whether or not the buyer side 550 buy-registers.

(l) Have the possible delivery date of the commercial product transmitted by the buyer side 550.

(m) Update the sale information.

### Sixth Embodiment

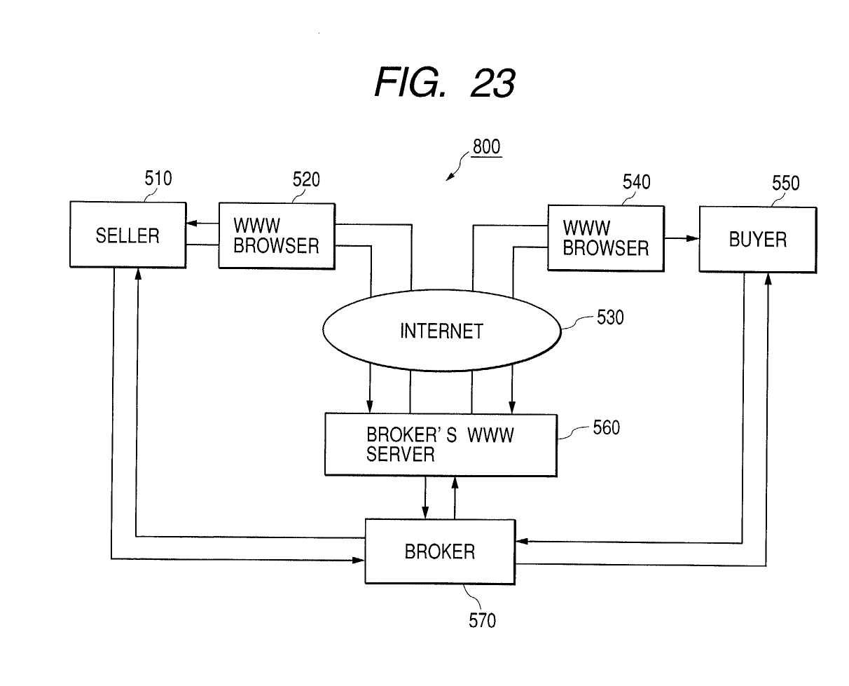

The present invention is applied to an electronic commerce system 800 as shown in FIG. 23 for instance.

(Configuration of the electronic commerce system 800)

As shown in the FIG. 23, the electronic commerce system 800 has a configuration not including the distributor 580 as opposed to the electronic commerce system 500 as shown in FIG. 16 having a configuration including the distributor 580.

It is because the subject commercial products in the electronic commerce system 800 are limited to those capable of simple method of sending such as mailing. As for the subject commercial products in this case, it should preferably be applied to small commercial products of high added value and light weight with no fear of damage in distribution, such as airplane tickets, concert tickets and expressway cards.

Moreover, in the electronic commerce system 800 in the FIG. 23, the portions operating in the same manner as in the electronic commerce system 500 as shown in FIG. 16 are given the same symbols, and detailed description thereof is omitted.

(Operation of the electronic commerce system 800)

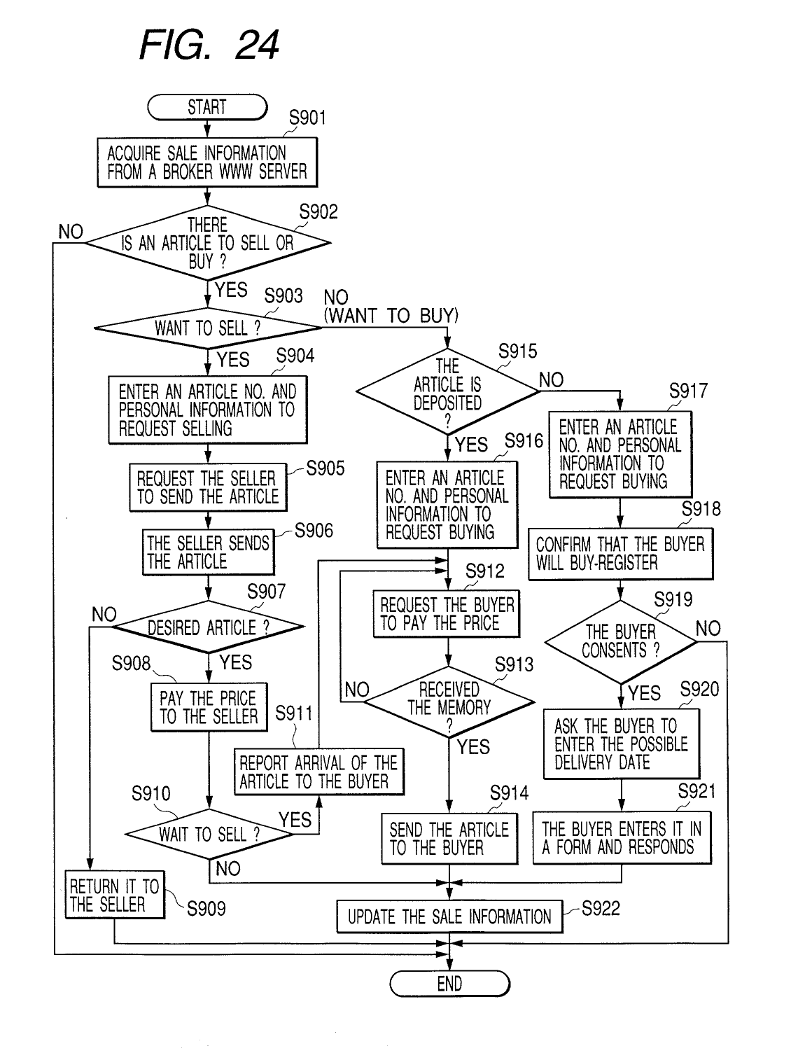

In the electronic commerce system 800 in this embodiment, operation according to the flowchart shown in the FIG. 24, for instance, is performed.

(1) In the case where the seller side 510 sells the commercial product

Step S901:

The user of the seller side 510 operates the WWW browser 520 running on his or her terminal unit and accesses the home page of the broker side 570 indicated by a predetermined URL (an address on the Internet). As an example of the screen of the home page in this case, the screen 750 as shown in the FIG. 22 is used.

It is equivalent for the seller side 510 to acquiring by using the WWW browser 520 the data files in HTML and so on, for instance, including commercial product information in the WWW server 560 managed and operated by the broker side 570.

Step S902 to 904:

Here, as this is the case where the seller side 510 sells a commercial product, it proceeds to the next step S904 via the processes of “There is a commercial product to sell” in the step S902 and “Want to sell” in the next step S903.

The user of the seller side 510 sees the screen 750 in the FIG. 22, checks whether or not an equivalent of the commercial product that the user wants to sell is listed on the sale information list, and if it is listed, he or she enters personal information such as the “name,” “address,” “telephone number” and “electronic mail address (e-mail),” and pushes the “Want to sell” button of the applicable commercial product information box to transmit the entered information to the WWW server 560 of the broker side 570 (sending a sell request).

Moreover, while this embodiment has a configuration wherein the commercial product is specified by pushing the “Want to sell” button in the applicable commercial product information box on the screen 750 in the FIG. 22, it is also feasible to enter the number indicating the commercial product (a commercial product number) directly just as in the fourth embodiment.

Step S905:

The WWW server 560 of the broker side 570 receives the sell request from the seller side 510 and requests the seller side 510 to deliver the commercial product according to the request.

For instance, the WWW server 560 sends as a acommercial product delivery request to the seller side 510 an HTML file including information such as the address, delivery limit and contract terms specified by the broker side 570.

Step S906:

The seller side 510 sends to the broker side 570 the commercial product desired to sell according to the commercial product delivery request sent from the WWW server 560 of the broker side 570.

Moreover, delivery of the commercial product in this case refers to a simple distribution such as mailing, and the commercial products to be sent are assumed to be those capable of such simple distribution.

Step S907:

The broker side 570 checks whether or not the commercial product sent from the seller side 510 is the desired commercial product.

Step S909:

As a result of the check in the step S907, in the case where it is not the desired commercial product, the broker side 570 sends back the commercial product to the seller side 510, and this process is terminated.

Step S908:

As a result of the check in the step S907, in the case where it is the desired commercial product, the broker side 570 pays the price for the commercial product to the seller side 510.

While various methods are applicable as the method of paying the price in this case, the broker side 570 acquires bank account information of the seller side 510 in advance from the input information of the seller side 510 in the step S904, in the case of using a method of transfer to a financial institution, for instance.

Step S910:

The WWW server 560 of the broker side 570 determines whether or not the commercial product that was distributed in the step S906 is in a state of wait-to-sell (whether or not there is a buyer wanting to buy the commercial product).

As a result of this determination, in the case where it is not in a state of wait-to-sell, it proceeds to the step S922 mentioned later.

Step S911, S912:

The WWw server 560 of the broker side 570 reports arrival of the commercial product (the subject commercial product) that was distributed in the step S906 to the buyer side (the buyer side 550 in this case) that is in a state of wait-to-sell as to the commercial product (step S911) and requests payment (step S912).

For instance, the WWW server 560 sends to the buyer side 550 e-mail including the information on arrival of the subject commercial product, a designated bank account of the broker side 570, a payment deadline and affirmation terms and so on.

Step S913:

The broker side 570 waits for payment from the buyer side 550.

Moreover, it is also feasible, in the case where the buyer side 550 rejects the arrival report and the request for payment notified by e-mail for some reason in the step S913, to be followed by telephone by the broker side 570 for instance.

In addition, in the case where the buyer side 550 does not pay the price by the deadline and there is another buyer side wanting to buy the subject commercial product, it is possible to provide the subject commercial product to the other buyer side.

Furthermore, as for the method of payment from the buyer side 550 to the broker side 570, it may be the method of transfer to a financial institution by using the same procedure as the above-mentioned price payment to the seller side 510, or the method of credit card settlement may be used.

Moreover, in the case of the method of credit card settlement, it is possible for the broker side 570 to give the buyer side 550 a notice of drawing out the amount in step 912 instead of a request for payment.

Step S914:

The broker side 570 checks the payment from the buyer side 550, and then distributes the commercial product to the buyer side 550.

Step S922:

The WWW server 560 of the broker side 570 updates the sale information according to the above-mentioned commercial product trade.

(2) In the case where the buyer side 550 buys the commercial product

Step S901:

The user of the buyer side 550 operates the WWW browser 540 running on his or her terminal unit and accesses the home page of the broker side 570 indicated by a predetermined URL (an address on the Internet).

It is equivalent for the buyer side 550 to acquiring by using the WWW browser 540 the data files in HTML and so on, for instance, including commercial product information in the WWW server 560 managed and operated by the broker side 570.

Step S902, S903, S915:

Here, as this is the case where the buyer side 550 buys a commercial product, it proceeds to the next step S915 via the processes of “There is a commercial product to buy” in the step S902 and “Want to buy” in the next step S903.

The user of the buyer side 550 sees the screen 750 in the FIG. 22, and checks whether or not an equivalent of the commercial product that the user wants to buy (a subject commercial product) is listed (whether or not there is a deposited commercial product).

As a result of this check, in the case where there is not a deposited commercial product, it proceeds to the processes from the step S917 mentioned later.

Step S916:

The user of the buyer side 550 enters on the screen 750 in the FIG. 22 personal information such as the “name,” “address,” “telephone number” and “electronic mail address (e-mail)” and pushes the “Want to buy” button of the applicable commercial product information box to transmit the entered information to the WWW server 560 of the broker side 570 (sending a buy request).

Moreover, while this embodiment has a configuration wherein the commercial product is specified by pushing the “Want to sell” button in the applicable commercial product information box on the screen 750 in the FIG. 22, it is also feasible, for instance, to enter the number indicating the commercial product (a commercial product number) directly just as in the fourth embodiment.

Step S912:

The WWW server 560 of the broker side 570 requests the buyer side 550 to pay the price according to the buy request from the buyer side 550.

For instance, the WWW server 560 sends to the buyer side 550 e-mail including the information on arrival of the subject commercial product, a designated bank account of the broker side 570, a payment deadline and affirmation terms and so on.

Step S913:

The broker side 570 waits for payment from the buyer side 550.

Moreover, it is also feasible, in the case where the buyer side 550 rejects the arrival report and the request for payment notified by e-mail for some reason in the step S913, to be followed by telephone by the broker side 570 for instance.

In addition, in the case where the buyer side 550 does not pay the price by the deadline and there is another buyer side wanting to buy the subject commercial product, it is possible to provide the subject commercial product to the other buyer side.

Furthermore, as for the method of payment from the buyer side 550 to the broker side 570, it may be the method of transfer to a financial institution by using the same procedure as the above-mentioned price payment to the seller side 510, or the method of credit card settlement may be used. Moreover, in the case of the method of credit card settlement, it is possible for the broker side 570 to give the buyer side 550 a notice of drawing out the amount instead of a request for payment in step 912.

Step S914:

The broker side 570 checks the payment from the buyer side 550, and then distributes the commercial product to the buyer side 550.

Step S922:

The WWW server 560 of the broker side 570 updates the sale information according to the above-mentioned commercial product trade.

Step S917:

On the other hand, in the above-mentioned step S915, in the case where there is no equivalent of the commercial product that the buyer side 550 wants to buy listed on the sale information list screen 750 in the FIG. 22, the user of the buyer side 550 enters on the screen 750 in the FIG. 22 personal information such as the “name,” “address,” “telephone number” and “electronic mail address (e-mail)” as well as detailed information on the commercial product and transmits the entered information to the WWW server 560 of the broker side 570 (sending a buy request).

Step S918:

The WWW server 560 of the broker side 570 receives the buy request from the buyer side 550 and sends to the buyer side 550 the data file for checking whether or not to buy-register the commercial product shown by the request.

Thus, the buyer side 550 sends a notice to the WWW server 560 of the broker side 570 as to whether or not it wants to buy-register.

Step S919:

The WWW server 560 of the broker side 570 determines from the notice from the buyer side 550 whether or not the buyer side 550 has consented to buy-register, and it executes the process from the next step S920 in the case where the buyer side 550 has consented to sell-register, and it terminates the process in the case where the buyer side 550 has not consented.

Step S920:

The WWW server 560 of the broker side 570 sends to the buyer side 550 the data file of the screen 670 for entering a possible delivery date of the commercial product as shown in the FIG. 20 for instance.

Step S921:

The buyer side 550 enters the possible delivery date of the commercial product on the screen 670 in FIG. 20, and responds with the entered information to the WWW server 560 of the broker side 570.

Step S922:

The WWW server 560 of the broker side 570 updates the sale information according to the responded information from the buyer side 550.

The above-mentioned is configuration and operation of the electronic commerce system 800 in this embodiment.

The processes executed on the WWW server 560 of the broker side 570 and the processes executed on the broker side 570 in this embodiment can be summarized into the four cases of 1) to 4) as follows.

Case 1) In the case where there is the commercial product that the seller side 510 desires to sell among the commercial products limited by the broker side 570 and there is the buyer side 550 that desires to buy the commercial product.

(1) Process of the WWW server 560

(a) Have personal information and the commercial product No. entered on the screen 750 in the FIG. 22 and sent by the seller side 510.

(b) Have the commercial product sent to the broker side 570 by the seller side 510.

(c) Report arrival of the commercial product to the buyer side 550.

(d) Request the buyer side 550 to pay the price.

(e) Update the sale information.

(2) Process of the broker side 570

(f) Check whether or not the commercial product sent from the seller side 510 is the desired commercial product.

(g) Pay the price of the commercial product to the seller side 510.

(h) Check the payment of the price from the buyer side 550, and send the commercial product to the buyer side 550 after the check.

Case 2) In the case where there is the commercial product that the seller side 510 desires to sell among the commercial products limited by the broker side 570 and there is no buyer side 550 that desires to buy the commercial product.

(1) Process of the WWW server 560

(i) Have personal information and the commercial product No. entered on the screen 750 in the FIG. 22 and sent by the seller side 510.

(j) Have the commercial product sent to the broker side 570 by the seller side 510.

(k) Update the sale information.

(2) Process of the broker side 570

(l) Check whether or not the commercial product sent from the seller side 510 is the desired commercial product.

(m) Pay the price of the commercial product to the seller side 510.

Case 3) In the case where there is the commercial product that the buyer side 550 desires to buy among the commercial products limited by the broker side 570 and the commercial product is in stock on the broker side 570.

(1) Process of the WWW server 560

(n) Have personal information and the commercial product No. entered on the screen 750 in the FIG. 22 and sent by the buyer side 550.

(o) Request the buyer side 550 to pay the price.

(p) Update the sale information.

(2) Process of the broker side 570

(q) Check the payment of the price from the buyer side 550, and send the commercial product to the buyer side 550 after the check.

Case 4) In the case where there is the commercial product that the buyer side 550 desires to buy among the commercial products limited by the broker side 570 and the commercial product is not in stock on the broker side 570.

(1) Process of the WWW server 560

(r) Have personal information and the commercial product No. entered on the screen 750 in the FIG. 22 and sent by the buyer side 550.

(s) Check whether or not the buyer side 550 buy-registers.

(t) Have the possible delivery date sent by the buyer side 550.

(u) Update the sale information.

Moreover, it is needless to say that the object of the present invention can also be attained by supplying to a system or a unit a storage medium storing program code of software for implementing the functions of the host and terminals in the first to sixth embodiments and having the program code stored in the storage medium read and executed by a computer (or a CPU or an MPU) of the system or unit.

In this case, the program code read from the storage medium itself implements the functions in the first to sixth embodiments, and so the storage medium storing the program code constitutes the present invention.

As the storage medium for supplying the program code, a ROM, a floppy disk, a hard disk, an optical memory disk, a magneto-optical disk, CD-ROM, CD-R, a magnetic tape, a nonvolatile memory card and so on can be used.

In addition, it is needless to say that not only execution of the program code read by the computer implements the functions in the first to sixth embodiments but also it includes the cases where an OS and so on operating on the computer executes all or part of the actual process based on instructions of the program code so as to implement the functions in the first to sixth embodiments thereby.

Furthermore, it is needless to say that this also includes the cases where the program code read from the storage medium is written to a memory of a feature expansion board inserted into the computer or a feature expansion unit connected to the computer, and then the CPU and so on of the feature expansion board or the feature expansion unit execute all or part of the actual process based on instructions of the program code so as to implement the functions in the first to sixth embodiments thereby.

As described above, according to the present invention, even the general user as the seller side can acquire information on the electronic contents (image or audio (music) data, static images, game software and so on) that the buyer side wanting to purchase arbitrary electronic contents desires to buy and browse it by using the information acquiring and browsing software operating on the computer and so on, and can sell the electronic contents to the buyer side desirous thereof in the case where an equivalent of the electronic contents product that the user wants to sell is listed.

Accordingly, it is possible even for a general user (consumer) to electronify upward trade wherein electronic contents can be sold to the buyer side (a dealer and so on) via a network and thereby prevent shortage of the digital contents and so on.

To be more specific, the following effects can be named.

(1) As the buyer side can present a guide for a purchase price to the seller side, it makes the trade efficient.

(2) As the buyer side can limit the electronic contents desired to purchase (solicited contents), the desired electronic contents can be acquired.

(3) As the buyer side can have the seller side automatically evaluate its electronic contents, it can save unnecessary work for the process.

(4) As the seller side can evaluate its electronic contents on its own, it can prevent the electronic contents from being unduly given over to the buyer side.

(5) As the evaluation results of electronic contents can be encrypted and outputted, the sellerside can prevent the evaluation results from being unduly changed.

(6) If the seller side is not satisfied with the evaluation results of the electronic contents (evaluated price and so on), it can reject the sale.

(7) As the electronic contents can be encrypted and sent, it can prevent the electronic contents from being unduly given over to and decrypted by anyone other than the rightful buyer.

(8) As the electronic contents can be sent via a network, it reduces processing time and saves unnecessary work.

(9) As the buyer side can check the electronic contents and then pays the price, it allows secure trade.

(10) As the seller side can send the degraded electronic contents for evaluation to the buyer side, it can prevent the electronic contents from being unduly given over to the buyer side.

(11) As the buyer side can perform evaluation of the electronic contents personally and by subjective evaluation, it allows more advanced evaluation thereof.

(12) As electronic contents evaluation can be personally performed again as to the electronic contents of which evaluation could not be automated, it makes the evaluation more efficient.

In addition, according to the present invention, it is possible to acquire information such as selling information on the commercial product that the seller side desires to sell and buying information on the commercial product that the buyer side desires to buy and browse it by using the information acquiring and browsing software operating on the computer and so on, and to request the buyer side or the seller side to trade in the commercial product in the case where an equivalent of the commercial product that the user wants to sell or buy is listed.

In this case, if it is configured so that the browsed information is managed by the broker side communicating with the seller side and the buyer side via a network and brokering the sale of the commercial product between the seller side and the buyer side, commercial product sale consignment from the seller side to the broker side and commercial product sale from the broker side to the buyer side can be entirely electronified except physical distribution, a commercial product check and part of price settlement. In addition, if it is configured so that the browsed information includes the information generated on the broker side (brokerage fees and so on), soundness of the commercial product trade can be improved.

To be more specific, the following effects can be named.

(1) The seller side can efficiently sell the commercial product desired to sell whatever it is.

(2) The seller side and the buyer side can clearly grasp the broker fee and so on respectively.

(3) The buyer side can buy-register whatever commercial product it desires to buy.

(4) The broker can reduce the risk since it does not actually have stocks of the commercial product.

(5) The seller side can have the commercial product desired to sell immediately bought by the broker side whether or not there is a buyer side.

(6) The buyer side can immediately acquire the commercial product desired to buy in the case it is in stock on the broker side.

(7) The broker can improve efficiency of sale since it becomes easier to adjust commercial product distribution. To be more specific, it is possible to accelerate a flow of the commercial product sale.

(8) The broker does not fail to collect the price.

What is claimed is:

1. An information processing apparatus on a seller side capable of sale of electronic contents via a network, comprising:
acquiring means for acquiring via said network information on the electronic contents that the buyer side wanting to purchase arbitrary electronic contents desires to buy; and
first providing means for providing to said buyer side via said network the electronic contents desired to sell corresponding to the information acquired by said acquiring means.

2. The information processing apparatus according to claim 1, wherein said first providing means encrypts and provides said electronic contents desired to sell.

3. The information processing apparatus according to claim 1, wherein said first providing means provides said electronic contents desired to sell based on evaluation results of said electronic contents.

4. The information processing apparatus according to claim 3, further comprising evaluation processing means for performing an evaluation process of said electronic contents desired to sell by using software provided by said buyer side via said network,
wherein said first providing means provides said electronic contents desired to sell based on evaluation results of said evaluation processing means.

5. The information processing apparatus according to claim 3, further comprising:
converting means for converting said electronic contents desired to sell to the electronic contents for evaluation; and
second providing means for providing to said buyer side via said network the electronic contents for evaluation acquired by said converting means,
wherein said first providing means provides said electronic contents desired to sell based on results of evaluation of said electronic contents for evaluation performed on said buyer side.

6. The information processing apparatus according to claim 3, further comprising:
evaluation processing means for performing an evaluation process of said electronic contents desired to sell by using software provided by said buyer side via said network;
converting means for converting said electronic contents desired to sell to the electronic contents for evaluation based on whether or not said evaluation process by said evaluation processing means has normally ended; and
second providing means for providing to said buyer side via said network the electronic contents for evaluation acquired by said converting means,
wherein said first providing means provides said electronic contents desired to sell based on the evaluation results of said evaluation processing means or the results of evaluation of said electronic contents for evaluation performed on said buyer side.

7. An information processing apparatus on a buyer side capable of sale of electronic contents via a network, comprising:
first providing means for providing to an arbitrary user on said network information on the electronic contents desired to buy via said network; and
first acquiring means for acquiring the electronic contents desired to sell provided by said arbitrary user in response to the information provided by said first providing means via said network.

8. The information processing apparatus according to claim 7, further comprising:
second providing means for providing to said arbitrary user via said network key information for encrypting said electronic contents desired to sell; and
decrypting means for decrypting the electronic contents encrypted by said key information,
wherein said first acquiring means acquires said electronic contents desired to sell encrypted on said arbitrary user side by using said key information, and
said decrypting means decrypts the encrypted electronic contents acquired by said first acquiring means.

9. The information processing apparatus according to claim 7, further comprising third providing means for providing to said arbitrary user via said network the software for evaluating the electronic contents that the user desires to sell,
wherein said first acquiring means acquires said electronic contents desired to sell provided by said arbitrary user based on the evaluation results of said electronic contents to sell by said software on said arbitrary user side.

10. The information processing apparatus according to claim 7, further comprising:
second acquiring means for acquiring said electronic contents desired to sell converted to the electronic contents for evaluation by said arbitrary user side; and
fourth providing means for providing to said arbitrary user via said network the evaluation results of said electronic contents for evaluation,
wherein said first acquiring means acquires said electronic contents desired to sell provided by said arbitrary user based on said evaluation results of said fourth providing means.

11. An information processing apparatus capable of commercial product trade via a network, comprising:
acquiring means for at least acquiring via said network either selling information that is information on a commercial product desired to sell on the seller side or buying information that is information on a commercial product desired to buy on the buyer side; and
answering means for answering whether to buy or sell as to the selling information or the buying information acquired by said acquiring means via said network.

12. The information processing apparatus according to claim 11,
wherein said acquiring means acquires the information managed on the broker side of commercial product sale on said network; and
said answering means answers to said broker side.

13. The information processing apparatus according to claim 12, wherein said acquiring means acquires via said network the information on the brokerage of the commercial product sale occurring on said broker side.

14. An electronic commerce system having a plurality of apparatuses including at least terminal units of the seller side and the buyer side connected via a network in a manner capable of mutual communication,
wherein at least one of said plurality of apparatuses has functions of the information processing apparatus according to claim 1.

15. An electronic commerce system for conducting sale of electronic contents between the seller side and the buyer side via a network, comprising:
a terminal unit on the seller side capable of activating information acquiring and browsing software;
a terminal unit on the buyer side;
a server unit managed and operated by said buyer side for at least managing either the information on the electronic contents desired to purchase on said buyer side or personal information on said seller side, sending and receiving data files according to a request by the information acquiring and browsing software on said seller side, and having a data storage area opened to said buyer side for receiving the electronic contents sent from said seller side;
a terminal unit on a financial institution side for performing a transfer transaction to said seller side according to a request from said buyer side; and
a communication network for connecting in a manner capable of communication said terminal unit on the seller side, said terminal unit on the buyer side, said server unit and said terminal unit on the financial institution side.

16. The electronic commerce system according to claim 15, wherein said server unit has at least server functions of either an HTTP (Hyper Text Transfer Protocol) server or an FTP (File Transfer Protocol) server, performs services according to a request from said information acquiring and browsing software and returns results thereof as predetermined data file, and also receives the electronic contents sent from said seller side.

17. An electronic commerce system for trading an arbitrary commercial product between a seller side and a buyer side via a network, comprising:
a terminal unit on the seller side capable of activating information acquiring and browsing software;
a terminal unit on the buyer side capable of activating the information acquiring and browsing software;
a terminal unit on the commercial product sale broker side;
a server unit managed and operated by said broker side;
a distributor side for at least conducting either distribution of the commercial product or receipt of a price of the commercial product according to a request by said broker; and
a communication network for connecting in a manner capable of communication at least one of said terminal unit on the seller side, said terminal unit on the buyer side, said terminal unit on the broker side, said server unit and said terminal unit on the distributor side.

18. The electronic commerce system according to claim 17, wherein said server unit has at least the functions of either the HTTP (Hyper Text Transfer Protocol) server or the FTP (File Transfer Protocol) server, performs the services according to a request from said information acquiring and browsing software and returns the results thereof as a data file, and also provides the e-mail services, stores and updates information including the commercial product sale brokerage information and the distribution schedule information of said distributor side at any time.

19. An electronic commerce system for trading an arbitrary commercial product between a seller side and a buyer side via a network, comprising:
a terminal unit on the seller side capable of activating information acquiring and browsing software;
a terminal unit on the buyer side capable of activating the information acquiring and browsing software;
a terminal unit on the commercial product sale broker side;
a server unit managed and operated by said broker side; and
a communication network for connecting in a manner capable of communication at least one of said terminal unit on the seller side, said terminal unit on the buyer side, said terminal unit on the broker side and said server unit.

20. The electronic commerce system according to claim 19, wherein said server unit has at least the functions of either the HTTP (Hyper Text Transfer Protocol) server or the FTP (File Transfer Protocol) server, performs services according to a request from said information acquiring and browsing software and returns results thereof as a predetermined data file, and also provides the e-mail services, stores and updates information including the commercial product sale brokerage information at any time.

21. The electronic commerce system according to claim 15, wherein said information acquiring and browsing software includes a WWW browser.

22. The electronic commerce system according to claim 15, wherein said communication network includes the Internet.

23. An electronic commerce method for trading electronic contents between a seller side and a buyer side via a network, comprising the steps that:
said seller side uses the information acquiring and browsing software to access the server unit managed and operated by said buyer side and perform membership registration;
said seller side acquires from said server unit on the buyer side a data file including information on the electronic contents desired to purchase on the buyer side and displays the data file by using said information acquiring and browsing software;
said seller side acquires the software required for this trade from said server unit on the buyer side;
said seller side evaluates the electronic contents to be provided to said buyer side by using the contents evaluation software included in said software required for this trade;
said seller side sends to said buyer side at least one of a contents number for identifying the electronic contents to be provided to said buyer side, member authentication information on said membership registration and said evaluation results;
said buyer side sends to said seller side information on at least one of an evaluated price, a reception number, key information used for encryption and electronic contents destination information for the subject electronic contents indicated by said contents number based on said evaluation results;
said seller side sends the subject electronic contents encrypted by using said encryption key to said buyer side in the case of being convinced of said evaluated price; and
said buyer side checks the subject electronic contents sent from said seller side and then requests the financial institution to transfer the amount of said evaluated price to said seller side for payment via said network.

24. The electronic commerce method according to claim 23, wherein said software required for this trade includes at least one of said contents evaluation software and the encryption software.

25. The electronic commerce method according to claim 23, wherein output values of the results of evaluation by said seller side using the contents evaluation software include a step of performing a process for preventing said seller side from estimating the evaluated price from the output values.

26. The electronic commerce method according to claim 25, further comprising a step of encrypting said output values.

27. An electronic commerce method for trading electronic contents between a seller side and a buyer side via a network, comprising the steps that:
said seller side uses the information acquiring and browsing software to access the server unit managed and operated by said buyer side and perform membership registration;
said seller side acquires from the server unit on said buyer side a data file including information on the electronic contents desired to purchase on said buyer side and displays the data file by using said information acquiring and browsing software;
said seller side acquires the software required for this trade from the server unit on said buyer side;
said seller side uses contents conversion software included in said software required for this trade to degrade the electronic contents to be provided to said buyer side and sends the degraded electronic contents as the electronic contents for evaluation to said buyer side;
said server unit on the buyer side sends to said seller side the reception number for the electronic contents sent from said seller side;
said buyer side evaluates the electronic contents for evaluation sent from said seller side;
said buyer side sends said evaluation results together with said reception number to said seller side;
said seller side encrypts and sends to said buyer side the subject electronic contents indicated by said reception number when convinced of said evaluation results; and
said buyer side checks the subject electronic contents sent from said seller side and then requests a financial institution via said network to transfer the amount of the evaluated price indicated by said evaluation results to said seller side for payment.

28. The electronic commerce method according to claim 27, wherein said software required for this trade includes at least one of said contents conversion software and encryption software.

29. The electronic commerce method according to claim 27, wherein the processing method that said seller side uses the contents conversion software to degrade the electronic contents includes a method principle-wise rendered incapable of restoring the original electronic contents.

30. A storage medium, wherein the processing steps of the electronic commerce method according to claim 23 are stored by a computer in a readable manner.

31. A program describing the processing steps of the electronic commerce method according to claim 23 in a form executable by a computer.

32. A storage medium, wherein the processing steps of the electronic commerce method according to claim 27 are stored by a computer in a readable manner.

33. A program describing the processing steps of the electronic commerce method according to claim 27 in a form executable by a computer.
